(19) United States
(12) Patent Application Publication
(10) Pub. No.: US 2017/0161693 A1
(43) Pub. Date: Jun. 8, 2017

(54) Escrow Payment Method

(71) Applicants: MP JF PTY LTD, Brisbane City (AU); KBH2230 PTY LTD, Brisbane City (AU)

(72) Inventors: Kevin Blay Hewson, Woolooware (AU); Matthew Philip John Forrest, Caringbah South (AU)

(21) Appl. No.: 15/325,546

(22) PCT Filed: Jul. 10, 2015
(86) PCT No.: PCT/AU2015/050392

§ 371 Date: Jan. 11, 2017

(30) Foreign Application Priority Data
Jul. 11, 2014 (AU) 2014902671
Feb. 25, 2015 (AU) 2015900667

(51) Int. Cl. G06Q 20/02; G06Q 20/38; G06Q 20/40; G06Q 20/10

(52) U.S. Cl. CPC G06Q 20/02; G06Q 20/10; G06Q 20/389; G06Q 20/405

(57) ABSTRACT

A computer-implemented method, computer system, and software for facilitating a payment transaction between a first party transaction account and a second party transaction account are disclosed. The method includes receiving at a transaction server funds data indicative of funds held in a holding account, the funds held in the holding account being received from the first party transaction account and being payable to the second party transaction account on account of services to be provided by a second party to a first party under a service agreement. The method also includes automatically notifying the second party, via a communications network, that an agreed minimum amount of funds has been deposited in the holding account, and receiving from the second party, via the communications network, performance data representative of completion by the second party of services specified in the service agreement. In addition, the method includes updating a transaction database to mark a performance record corresponding to services specified in the service agreement as being completed by the second party, automatically notifying the first party, via the communications network, that the second party has indicated performance of the services specified in the service agreement, and receiving from the first party, via the communications network, confirmatory performance data representative of approved completion by the second party of services specified in the service agreement. Finally, the method includes transmitting from the transaction server to a payment server authorised to action transactions from the holding account, via the communication network, authorisation data to enable the transfer of at least the agreed minimum amount of funds from the holding account to the second party transaction account.

### TECHNICAL FIELD

The disclosure relates, generally, to a computer-implemented method, system, and software for facilitating commercial transactions and, more particularly, to a computer-implemented method, system, and software to facilitate a payment transaction between a contractor and a customer through a secure online transaction management system. The disclosure has particular, but not necessarily exclusive, application to commercial transactions between a customer and a building contractor, and to managing the progress of a job so as to avoid disputes and reduce risk for both parties to the transaction.

### BACKGROUND

It is common in many commercial transactions involving payment for project services, between a contractor and a customer, for there to be disputes in relation to the quality or timeliness of the work performed (from the customer perspective), and/or the right to payment for services rendered (from the contractor perspective), which may occur either partly in advance of or following full completion of those services.

A customer will often engage the services of a contractor in relation to, for example, building services, repair services, cleaning services, maintenance services and the like. When dealing with a contractor such as, for example, a tradesman or service provider, the customer may experience uncertainty regarding the contractor's reliability, the likelihood that the contractor will perform the job to a requisite standard and quality, and/or that the contractor will actually complete the job within a reasonable timeframe. Adding to this uncertainty, customers are often required to provide contractors with large deposits, or full advance payments, prior to any work commencing. There is often a lack of accountability on the part of the contractor, and a lack of a clear paper trail detailing progress payments between the customer and contractor. The general uncertainty experienced by the customer can also be increased as a result of poor communications between the parties during the job, and as a result of a general lack of standardisation across various professional and trade industries.

Similarly, a contractor may have concerns that a customer may not pay for the work done, or that the customer may dispute that the work was carried out as agreed (e.g. that the work was not carried out to specification, that the work was not carried out to the requisite standard and quality, or that the work was not carried out within a reasonable time frame). Contractors have a significant concern in outlaying money to purchase supplies and labour, and to partially (or fully) perform the job before receiving any payment. It is not uncommon for customers to pay late or, in some instances, fail to pay at all, knowing that the contractor may be unlikely to take any significant legal action. In this regard, contractors often have to dedicate large amounts of time and resources to pursuing debtors, which often results in a substantial additional expense to the contractor.

In this specification where a document, act or item of knowledge is referred to or discussed, this reference or discussion is not an admission that the document, act or item of knowledge or any combination thereof was at the priority date, publicly available, known to the public, part of the common general knowledge; or known to be relevant to an attempt to solve any problem with which this specification is concerned.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

The present invention provides a computer-implemented method, system, and software to facilitate payment transactions between, for example, a customer and a building contractor. The system is designed to be scalable and equally applicable to service arrangement commonly entered into by developers, councils, construction companies, subcontractors, and government organizations. However, it should be appreciated that the present invention is not limited to use in relation to building and construction contracts, but can be used in respect of other contractual arrangements where goods and/or services are being provided by a first party and payments for those goods and/or services are being made by a second party. This specification will use a building contract between a builder (contractor) and customer as a representative example, but the invention is not so limited.

A computer-implemented method of facilitating a payment transaction between a first party transaction account and a second party transaction account, the method comprising:

(a) receiving at a transaction server funds data indicative of funds held in a holding account, the funds held in the holding account being received from the first party transaction account and being payable to the second party transaction account on account of services to be provided by a second party to a first party under a service agreement;

(b) automatically notifying the second party, via a communications network, that an agreed minimum amount of funds has been deposited in the holding account;

(c) receiving from the second party, via the communications network, performance data representative of completion by the second party of services specified in the service agreement;

(d) updating a transaction database to mark a performance record corresponding to services specified in the service agreement as being completed by the second party;

(e) automatically notifying the first party, via the communications network, that the second party has indicated performance of the services specified in the service agreement;

(f) receiving from the first party, via the communications network, confirmatory performance data representative of approved completion by the second party of services specified in the service agreement; and

(g) transmitting from the transaction server to a payment server authorised to action transactions from the holding account, via the communication network, authorisation data to enable the transfer of at least the agreed minimum amount of funds from the holding account to the second party transaction account.

Step (a) of the method may also comprise one or more of the following steps:

receiving at the transaction server from the first party and/or the second party, via the communications network, transaction data that includes the agreed minimum amount of funds required to be deposited in the holding account;

updating the transaction database to store the agreed minimum amount of funds required to be held in the holding account in a funds record;

retrieving from the transaction database the funds record corresponding to the agreed minimum amount of funds required to be held in the holding account before the second party will commence the services specified in the service agreement;

comparing the funds data with the funds record corresponding to the agreed minimum amount of funds required to be held in the holding account to determine whether the funds held in the holding account represent at least the agreed minimum amount of funds required to be held in the holding account; and

updating the transaction database to mark a transaction record corresponding to the holding account as containing an agreed minimum amount of funds.

The method may further comprise the step of associating the agreed minimum amount of funds with the funds record in the transaction database corresponding to the agreed minimum amount of funds required to be held in the holding account.

At least a portion of the funds held in the holding account may be received from the first party transaction account. Alternatively, or in addition, at least a portion of the funds held in the holding account may be received from a third party transaction account as a result of a pre-existing credit arrangement between the first party and a third party finance provider.

The holding account may be facilitated by a financial institution or third-party transaction service provider and managed by the payment server.

The method may comprise the further steps of:

receiving at the transaction server funds data indicative of funds held in a sub-holding account, the funds held in the sub-holding account being received from a further second party transaction account and being payable to a subcontracting party transaction account on account of a subset of the services to be provided by a subcontracting party to the second party;

automatically notifying the subcontracting party, via a communications network, that a second agreed minimum amount of funds has been deposited in the sub-holding account;

receiving from the subcontracting party, via the communications network, performance data representative of completion by the subcontracting party of the subset of the services;

updating the transaction database to mark a performance record corresponding to services specified in the service agreement as being completed by the subcontracting party;

automatically notifying the first party and/or the second party, via the communications network, that the subcontracting party has indicated performance of the subset of the services;

receiving from the first party and/or the second party, via the communications network, confirmatory performance data representative of approved completion by the subcontracting party of the subset of the services; and

transmitting from the transaction server to a payment server authorised to action transactions from the sub-holding account, via the communication network, authorisation data to enable the transfer of at least the second agreed minimum amount of funds from the sub-holding account to the subcontracting party transaction account.

The method may also comprise one or more of the following preliminary steps:

receiving at the transaction server from the first party and/or second party, via the communications network, transaction data that includes the second agreed minimum amount of funds required to be deposited in the sub-holding account;

updating the transaction database to store the second agreed minimum amount of funds required to be held in the sub-holding account in a funds record;

retrieving from the transaction database the funds record corresponding to the second agreed minimum amount of funds required to be held in the sub-holding account before the subcontracting party will commence the subset of the services;

comparing the funds data with the funds record corresponding to the second agreed minimum amount of funds required to be held in the sub-holding account to determine whether the funds held in the sub-holding account represent at least the second agreed minimum amount of funds required to be held in the sub-holding account; and

updating the transaction database to mark a transaction record corresponding to the sub-holding account as containing the second agreed minimum amount of funds.

At least a portion of the funds held in the sub-holding account may be received from the further second party transaction account. Alternatively, or in addition, at least a portion of the funds held in the sub-holding account may be received from a third party transaction account as a result of a pre-existing credit arrangement between the second party and a third party finance provider. Further, the second party transaction account may be the same as the further second party transaction account.

As with the holding account, the sub-holding account may be facilitated by a financial institution or third-party transaction service provider and managed by the payment server. In addition, the sub-holding account may also receive funds payable to one or more additional subcontracting parties on account of those additional subcontracting parties performing services specified in the service agreement.

The step of transmitting from the transaction server to the payment server authorisation data to enable the transfer of at least the second agreed minimum amount of funds from the sub-holding account to the subcontracting party transaction account may be independent of and may precede the step (g) of transmitting from the transaction server to the payment server authorisation data to enable the transfer of at least the agreed minimum amount of funds from the holding account to the second party transaction account.

The transaction data may further include one or more of:

a transaction identifier associated with the holding account; and

a transaction identifier associated with second party transaction account.

Software when installed on a server causes the server to perform the above method.

A computer system for facilitating a payment transaction between a first party transaction account and a second party transaction account; the computer system comprising:

a computer server accessible through a communications network, the computer server arranged to receive transaction data through the communications network;

a processor, communicatively coupled to the computer server, to one or more means for graphical display of information, and to one or more means for receiving input, the processor being configured to:
(a) receive at the computer server funds data indicative of funds held in a holding account, the funds held in the holding account being received from the first party transaction account and being payable to the second party transaction account on account of services to be provided by a second party to a first party under a service agreement;
(b) automatically transmit to the second party, via a communications network, a notification that an agreed minimum amount of funds has been deposited in the holding account;
(c) receive from the second party, via the communications network, performance data representative of completion by the second party of services specified in the service agreement;
(d) update a transaction database to mark a performance record corresponding to services specified in the service agreement as being completed by the second party;
(e) automatically transmit to the first party, via the communications network, a notification that the second party has indicated performance of the services specified in the service agreement;
(f) receive from the first party, via the communications network, confirmatory performance data representative of approved completion by the second party of services specified in the service agreement;
(g) transmit from the computer server to a payment server authorised to action transactions from the holding account, via the communication network, authorisation data to enable the transfer of at least the agreed minimum amount of funds from the holding account to the second party transaction account.

It should be understood that one or more of the optional features described above with reference to the computer-implemented method may also be applicable to the above-described computer system (where appropriate).

A method as performed by a payment transaction application installed on a mobile communication device to facilitate a payment transaction between a first party transaction account and a second party transaction account, the payment transaction relating to a service agreement between a first party and a second party, the method comprising:

(a) receiving from a transaction server, via a communications network, a notification that an agreed minimum amount of funds has been deposited in a holding account;

(b) transmitting to the transaction server, via the communications network, performance data representative of completion by the second party of services specified in the service agreement;

(c) receiving from the transaction server, via the communications network, confirmatory performance data representative of approval by the first party of the services completed by the second party; and

(d) receiving from the transaction server, via the communication network, a notification that the transfer of at least the agreed minimum amount of funds from the holding account to the second party transaction account has been authorised.

The communication device may comprise a display device to facilitate interaction by the first party and/or second party with the payment transaction application.

In step (b) of the method, the performance data may also include one or more digital images illustrating the services performed by the second party in accordance with the service agreement.

Software that when installed on a mobile communication device causes the mobile communication device to perform the above method. An Application Programming Interface that when installed on a mobile communications device as part of a payment transaction application causes the mobile communication device to perform the above method.

A particular advantage of the computer-implemented method, computer system, and software described above is the increased level of confidence for both the customer and the contractor in relation to the performance of the overall transaction and, more specifically, the increased confidence that payments will be made appropriately upon satisfactory completion of the job stages, and that consistent communication will be maintained between the parties through, for example, the use of automated electronic notifications (AEN) generated upon completion of each stage of the job. Such AENs may, for example, include push notifications, SMS messages, email messages, text messages or any other suitable electronic notification means.

According to a representative embodiment, the method, system, and software described may involve interaction with an account (referred to in this specification as a ‘holding account’). This holding account may, for example, be a trust account or similar type of account (depending on the particular jurisdiction). Funds may be deposited into this account by a customer, and held either for payment to a contractor (for example, upon successful completion of a job or job stage) or for return to the customer (for example, in the event that the job, or a portion of the job, is not successfully completed). The method may utilise certain rules, in conjunction with input from the contractor and/or customer, to determine when, and whether, payment is to be made from the holding account, to whom, and in what amount.

In a representative embodiment, the method, system, and software described may also be regarded as implementing a secure escrow arrangement that requires customers to pay mutually agreed progress deposits into the holding account. The customer and contractor preferably agree on a number of stages of work, the requirements of each stage, and the progress payments expected for each stage of each job, with data reflecting this agreement being input to the system by either the customer or contractor. An advantage of this structure is that it requires the parties to agree upfront on the individual stages of the job, and avoids confusion about when each payment amount is required to be paid. For example, each job stage payment may not be paid to the contractor until both parties agree that the job stage is complete. As a result, the customer is empowered to ask for completion of the job to a satisfactory level of quality. Similarly, the contractor has confidence that they will receive payment upon achieving completion of the job (or individual job stage) to the pre-agreed level of quality, particularly since the funds are already being held in escrow in the holding account.

When a customer deposits funds into the holding account, the contractor preferably receives an AEN, an example being a confirmatory email, stating that the funds have been deposited. An advantage of this approach is that the contractor may then use this confirmation to obtain credit for upfront purchases (e.g. materials and/or labour) required, as suppliers to the contractor will have increased confidence that payment will be made upon completion of the job.

Upon completion of each state of the job by the contractor, the contractor may access the system to input and confirm that the stage has been completed. In response, an AEN (including, for example, an email message or other electronic message) may be sent to the customer, informing the customer that the contractor has recorded the completion of a stage of the job and requesting permission to release to the contractor the payment corresponding to that stage of the job. The customer may then have the opportunity to verify that the job (or stage of the job) has satisfactorily completed before releasing payment to the contractor. In a particularly preferred embodiment, both parties may upload to the system photographs and other evidence to demonstrate that work has or has not been satisfactorily completed.

The method, system, and software described in the above preferably improve communication between the customer and the contractor in two ways. Firstly, standardised electronic notifications may be automatically sent to both the customer and the contractor before and after each job stage, informing them of the terms of the agreement and payment schedule, informing them of requests for next and further payments, and informing them of the completion of each of the job stages. Secondly, the method, system, and software described may standardise the processes and requirements across multiple contractor and trade industries by providing a system that addresses current industry problems.

A further advantage of the method, system, and software described is that it preferably decreases the need for legal action in respect of non-payments, as the payment is already being held in escrow in the holding account. Neither party can use the exclusive control of funds as leverage in the transaction. As a result, the contractor has increased confidence that they will be paid upon the satisfactory completion of the job (or job stage), and the customer is satisfied that the job will not progress to payment or to the next stage until they are satisfied with the work completed. The system may automatically electronically notify the contractor, by way of an AEN, when the customer deposits money into the holding account.

In a representative embodiment, the method, system and software may also provide for a mediation facility in the event that disagreements cannot be resolved between the parties. Such a mediation facility may allow for an independent expert to be engaged by the parties to consider the validity of each argument, and reach a decision regarding an apportionment of funds to the contractor in accordance with the work performed (and the standard of quality to which that work has been performed). The mediator may then communicate this information to the system so that the relevant funds (or portion of those funds) held in the holding account can be paid to the contractor (assuming some payment is to be made, which may not always be the case).

A still further advantage of the method, system, and software described is that it may address many known record-keeping problems by providing a clear and automated transactional history for each and every payment made between the customer and contractor from the holding account, as well as by providing an electronic record of communications between the contractor and the customer. In a particularly preferred embodiment, the system may also interface with social media platforms, allowing users to engage in activities such as, for example, completing performance rating templates, and leaving specific comments about a particular contractor.

### BRIEF DESCRIPTION OF DRAWINGS

Embodiments of the present invention will now be described with reference to the accompanying drawings. These embodiments are given by way of illustration only and other embodiments of the invention are also possible. Consequently, the particularity of the accompanying drawings is not to be understood as superseding the generality of the preceding description. In the drawings:

FIG. 1 is a schematic block diagram illustrating a system of facilitating a payment transaction in accordance with a representative embodiment of the present invention;

FIG. 2 is a schematic block diagram illustrating a web-based system of facilitating a payment transaction in accordance with an alternative embodiment of the present invention;

FIG. 3 is a flowchart illustrating an exemplary method of facilitating a payment transaction in accordance with a representative embodiment of the present invention;

FIG. 4 is a schematic block diagram illustrating the interaction between various parties to a payment transaction in accordance with method shown in FIG. 3.

FIG. 5 is a flowchart illustrating an exemplary method of authenticating receipt of funds in a holding account in accordance with a representative embodiment of the present invention;

FIG. 6 is a flowchart illustrating an exemplary method of resolving a dispute between parties to a payment transaction in accordance with a representative embodiment of the present invention;

FIG. 7 is a flowchart illustrating an exemplary method of facilitating a payment transaction using a financier in accordance with an alternative embodiment of the present invention;

FIG. 8 is a schematic block diagram illustrating the interaction between various parties to a payment transaction in accordance with method shown in FIG. 7;

FIG. 9 is a flowchart illustrating an exemplary method of facilitating a payment transaction, wherein certain services are subcontracted, in accordance with an alternative embodiment of the present invention;

FIG. 10 is a schematic block diagram illustrating the interaction between various parties to a payment transaction in accordance with method shown in FIG. 9;

FIG. 11 is a flowchart illustrating an example of the operation of the method of facilitating a payment transaction in accordance with an exemplary embodiment of the present invention;

FIG. 12A is a flow diagram illustrating a site map of a web-based implementation of a system of facilitating a payment transaction in accordance with a representative embodiment of the present invention. FIG. 12B is a flow diagram illustrating two separate login streams that may be utilised by parties to a payment transaction in accordance with the web-based implementation of the system shown in FIG. 12A.

FIGS. 13A to 13M show a series of screenshots illustrating the functionality of a web-based implementation of a system of facilitating a payment transaction in accordance with a representative embodiment of the present invention.

FIGS. 14A to 14B show a series of screenshots illustrating the ‘Add a Variation’ functionality of a web-based implementation of a system of facilitating a payment transaction in accordance with a representative embodiment of the present invention;

FIGS. 15A to 15E show a series of screenshots illustrating the ‘Retainer’ functionality of a web-based implementation of a system of facilitating a payment transaction in accordance with a representative embodiment of the present invention; and

FIGS. 16A to 16D show a series of screenshots illustrating the ‘Bank Finance Module’ functionality of a web-based implementation of a system of facilitating a payment transaction in accordance with a representative embodiment of the present invention.

### DESCRIPTION OF EMBODIMENTS

Representative embodiments of the present invention relate to a computer implemented method and system of facilitating a payment transaction between a first party transaction account and a second party transaction account. The invention is particularly useful in relation to facilitating a payment transaction between a customer and a building contractor and it will therefore be convenient to describe the invention in that environment. However, it should be understood that the invention is not limited to this preferred embodiment, and may be implemented in other environments.

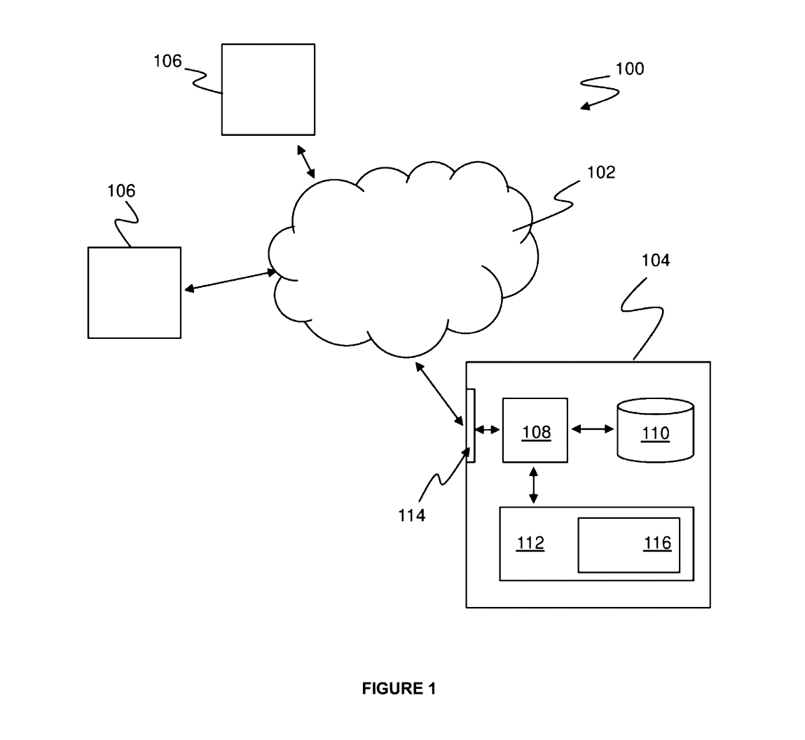

FIG. 1 is a schematic diagram illustrating a system 100 within which embodiments of the present invention may be implemented.

The system 100 uses a communications network 102, e.g. the Internet, to facilitate a payment transaction service between a first party transaction account and a second party transaction account, the first and second parties being parties to a service agreement. This embodiment, in particular, enables effective commercial transactions between a contractor and a customer through a secure online transaction management system.

In the exemplary embodiment 100, a server 104 executes a web server software application for provision of services to user devices 106. Communication between the server 104 and the devices 106 is thus conveniently based upon standard hypertext transfer protocol (HTTP) and/or secure hypertext transfer protocol (HTTPS).

The devices 106 (i.e. ‘clients’) may be fixed devices such as desktop computers, and/or mobile devices such a smart phones, tablets, notebook computers and so forth. As will be appreciated by persons skilled in the communication arts, various mechanisms and technologies are available to provide access to the Internet 102 from fixed and mobile devices 106, and all such technologies fall within the scope of the present invention.

The server 104 may generally comprise one or more computers, each of which includes at least one microprocessor 108. The number of computers and processors 108 generally depends upon the required processing capacity of the system, which in turn depends upon the number of concurrent user devices 106 which the system is designed to support. In order to provide a high-degree of scalability, for example when supporting a global user base, the server 104 may utilise cloud-based computing resources, and/or may comprise multiple server sites located in different geographical regions. The use of a cloud computing platform, and/or multiple server sites, enables physical hardware resources to be allocated dynamically in response to service demand. These and other variations, regarding the server computing resources, will be understood to be within the scope of the present invention, although for simplicity the exemplary embodiments described herein employ only a single server computer 104 with a single microprocessor 108.

The microprocessor 108 is interfaced to, or otherwise operably associated with, a non-volatile memory/storage device 110. The non-volatile storage 110 may be a hard-disk drive, and/or may include solid-state non-volatile memory such as read-only memory (ROM), flash memory, or the like. The microprocessor 108 is also interfaced to volatile storage 112, such as random access memory (RAM), which contains program instructions and transient data relating to the operation of the server 104.

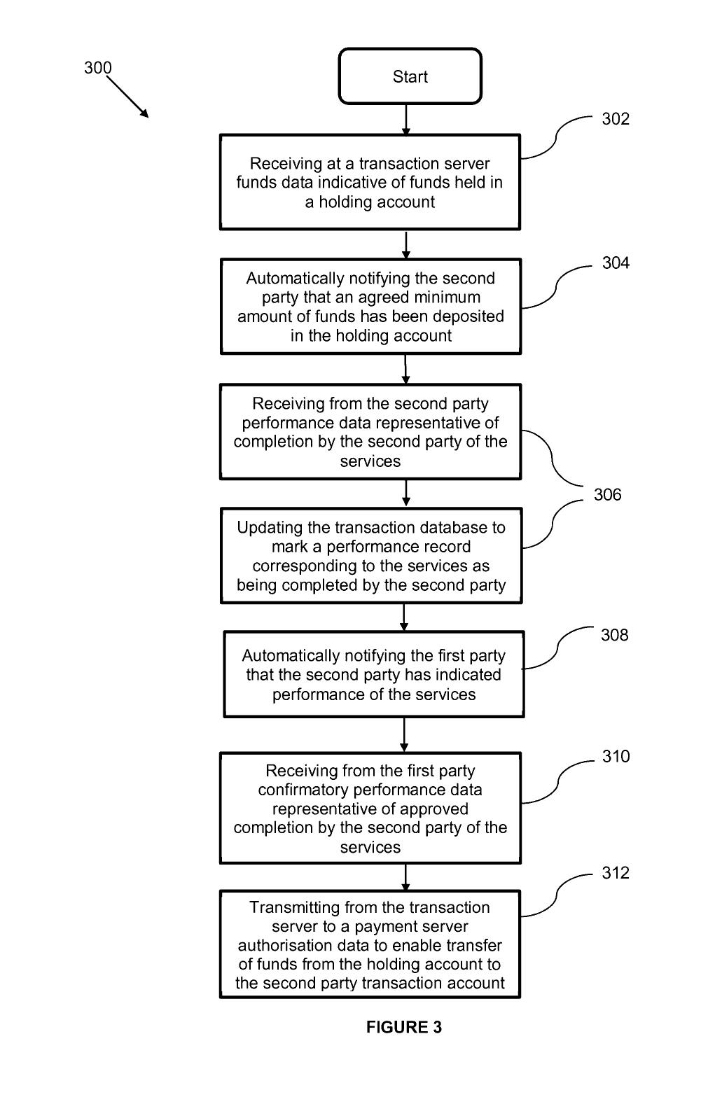

In a conventional configuration, the storage device 110 maintains known program and data content relevant to the normal operation of the server system 104, including operating systems, programs and data, as well as other executable application software necessary to the intended functions of the server 104. In the embodiment shown, the storage device 110 also contains program instructions which, when executed by the processor 108, enable the server computer 104 to perform operations relating to the implementation of services and facilities embodying the present invention, such as are described in greater detail below with reference to FIGS. 3 to 16. In operation, instructions and data held on the storage device 110 are transferred to volatile memory 112 for execution on demand.

The microprocessor 108 is operably associated with a network interface 114 in a conventional manner. The network interface 114 facilitates access to one or more data communications networks, including the Internet 102, to enable communication between the server 104 and the client devices 106. In use, the volatile storage 112 includes a corresponding body of 116 of program instructions configured to perform processing and operations embodying features of the present invention, for example as described below with reference to FIGS. 3 to 16.

For example, the program instructions 116 include instructions embodying a web server application. Data stored in the non-volatile 110 and volatile 112 storage comprises web-based code for presentation and/or execution on user devices 106, such as HTML and/or JavaScript code, for facilitating a web-based implementation of a payment transaction service.

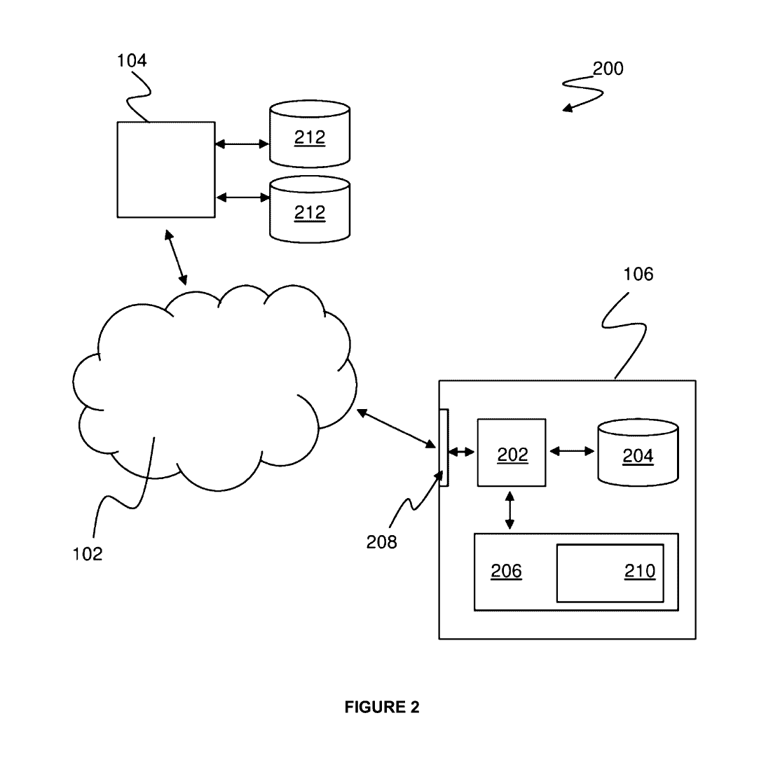

An alternative implementation 200, again by way of example only, is illustrated in the schematic diagram of FIG. 2. In this alternative embodiment, at least a portion of the executable program code implementing the system is executed within the client devices 106. As shown, each client device is typically a computing device, including at least one microprocessor 202, non-volatile storage 204 and volatile storage 206. Each client device 106 also has a network interface 208, operably associated with the microprocessor 202 in a conventional manner. Accordingly, the client devices 106 are able to conduct computational processing by execution of programs stored locally, in the volatile 206 and non-volatile 204 storage, and/or downloaded via the Internet 102 through the network interface 208.

In the embodiment 200 the server 104 may be in communication with one or more databases 212, which may contain records relating to the operation of the payment transaction service, and additionally may include downloadable software components for execution on the client device 106. For example, a portion of the system may be implemented via program instructions developed in a language such as Java, or some other suitable programming language, which execute on the client device 106 in order to retrieve data via the server 104, and implement some or all of the functionality of the exemplary payment transaction service as described below with reference to FIGS. 3 to 16.

Client-side implementations may also include downloadable and executable code in the form of browser plugins, such as ActiveX controls for Windows-based browsers, and/or other applets or apps configured for execution within a browser environment or within a smartphone operating system environment, such as an Apple iOS environment or an Android environment.

Various implementations of embodiments of the invention will be apparent to persons skilled in the art of software engineering, including various combinations of server-side and client-side executable program components.

In accordance with an exemplary embodiment of the present invention, the computer-implemented method and system of facilitating a payment transaction require access to transaction data which is preferably stored within a centralised database 212. The transaction data may include, but is not limited to, the transaction account details of the parties to the payment transaction (including a unique identifier for each of the transaction accounts of the parties, which may be provided by a financial institution(s) responsible for managing the transaction accounts), the account details for a holding account into which funds can be paid and from which funds can be released ((including a unique identifier for the holding account, which may be provided by a financial institution(s) responsible for managing the holding account), and details regarding the transaction (including, for example, the minimum amount of funds required to be deposited into the holding account).

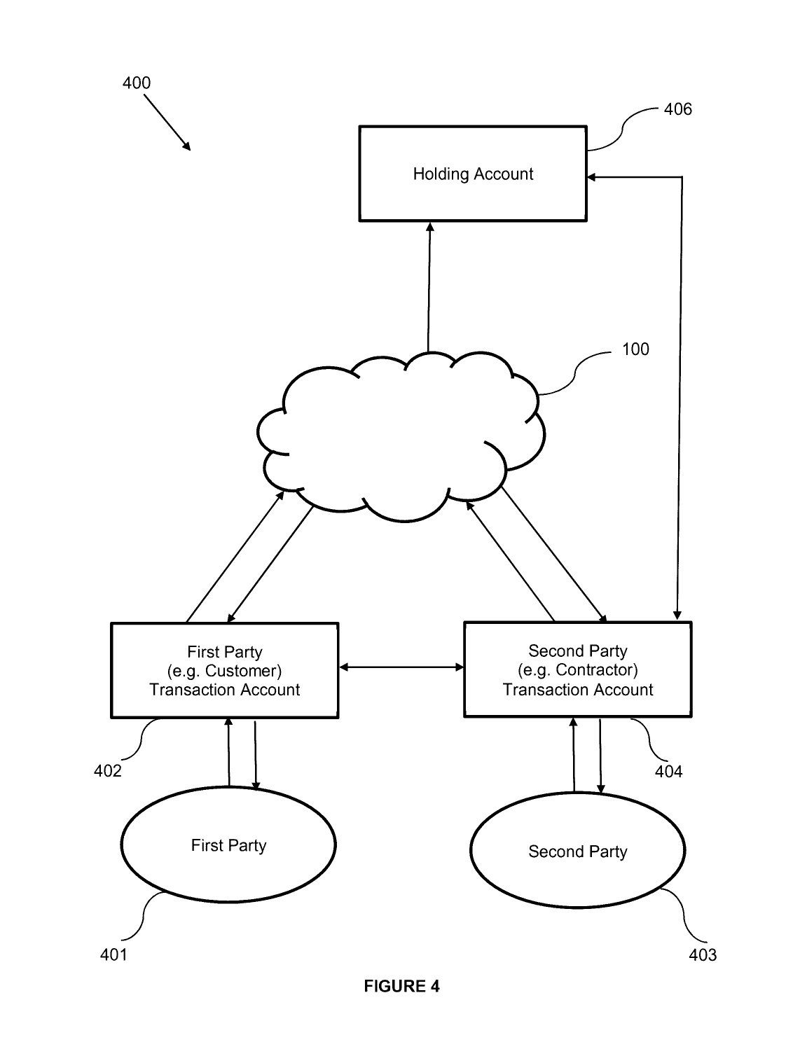

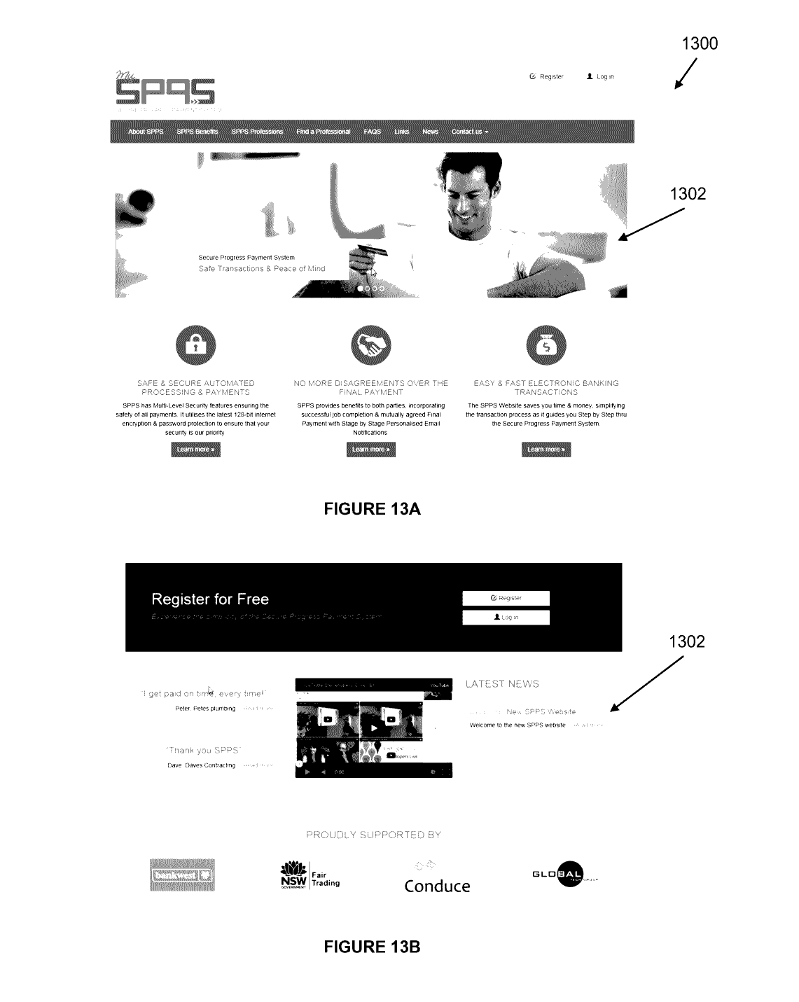

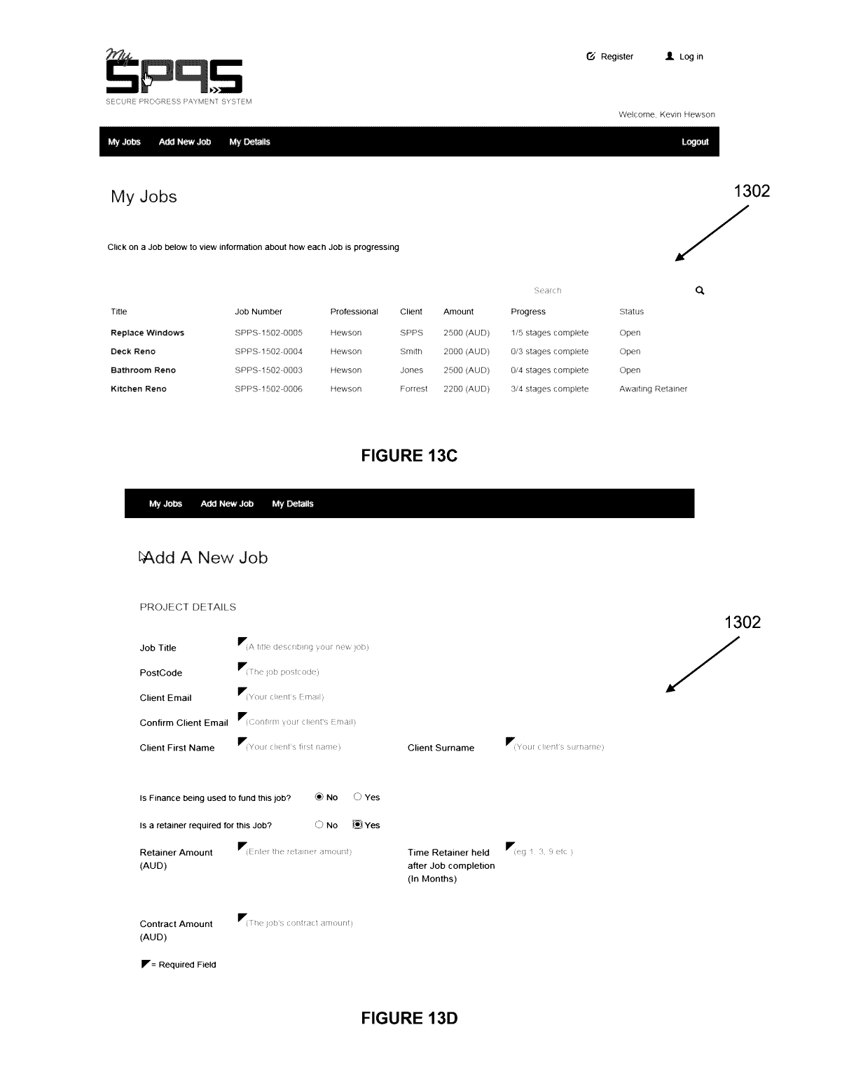

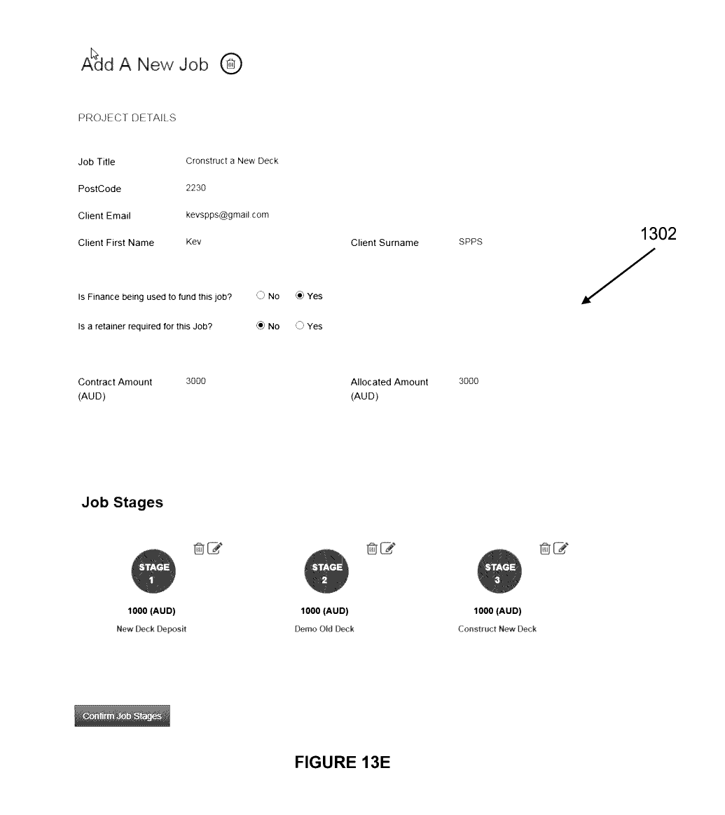

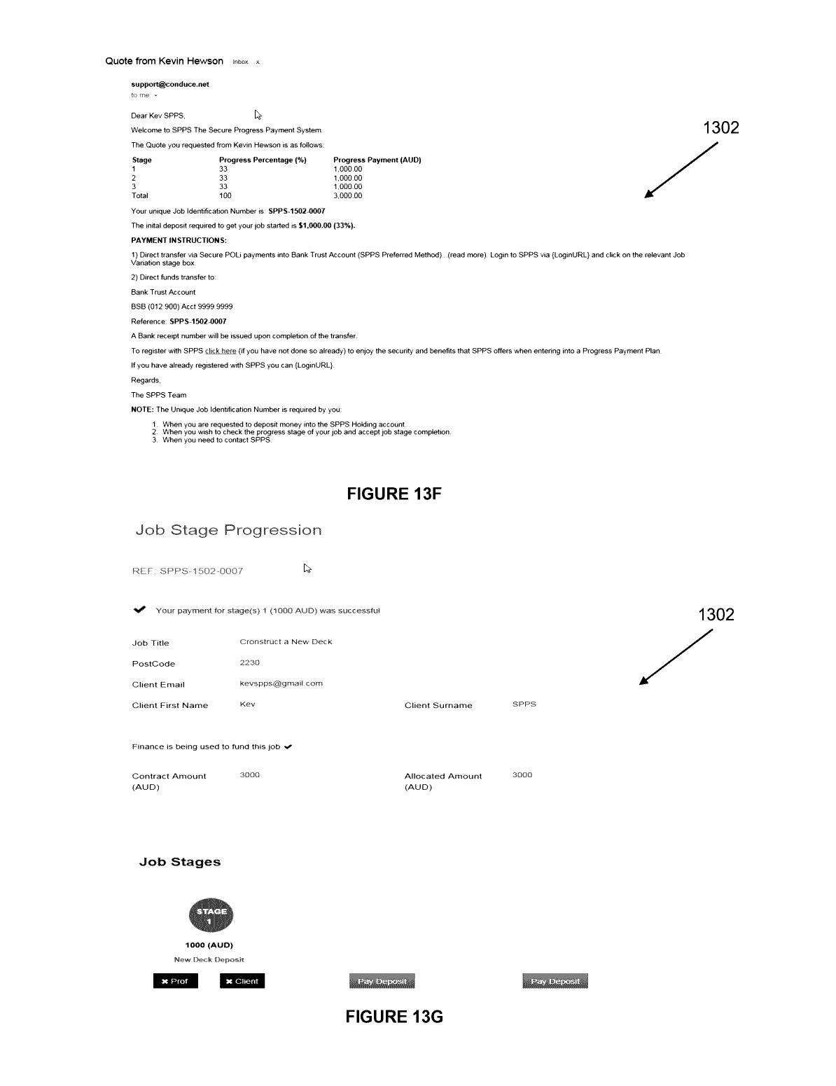

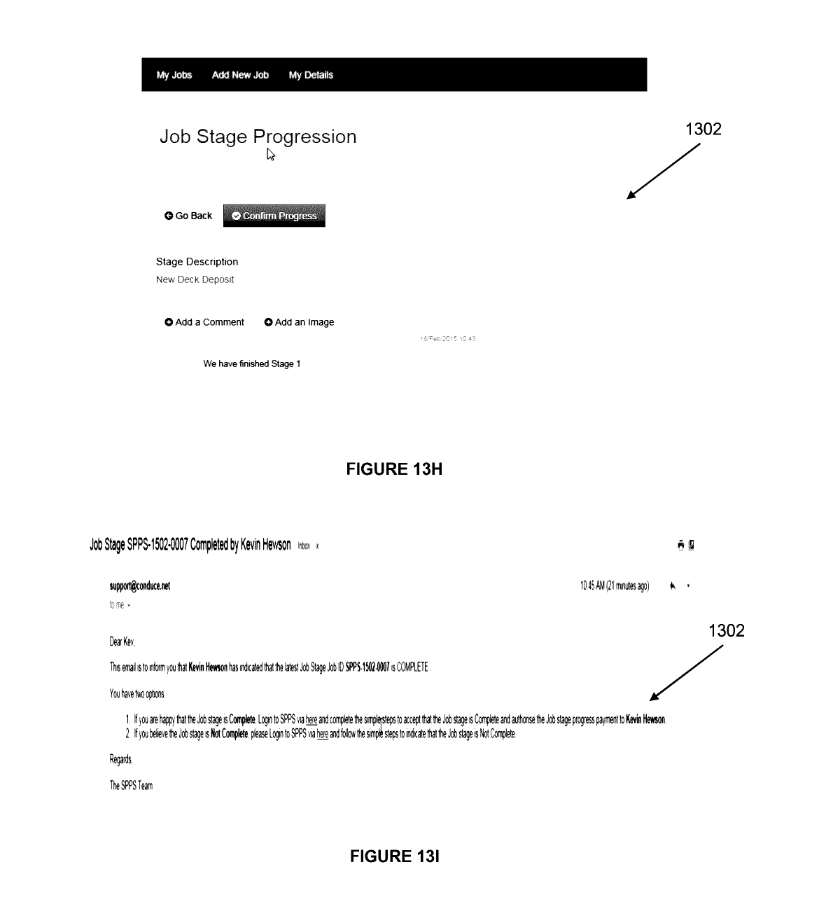

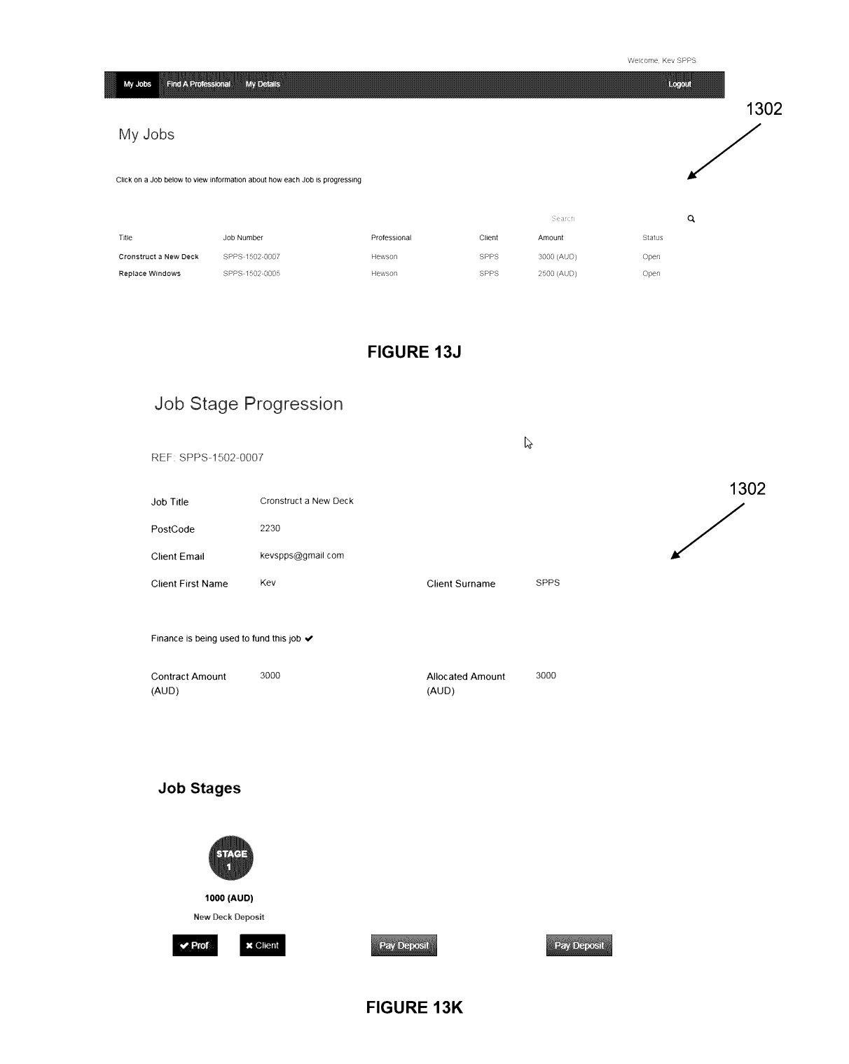

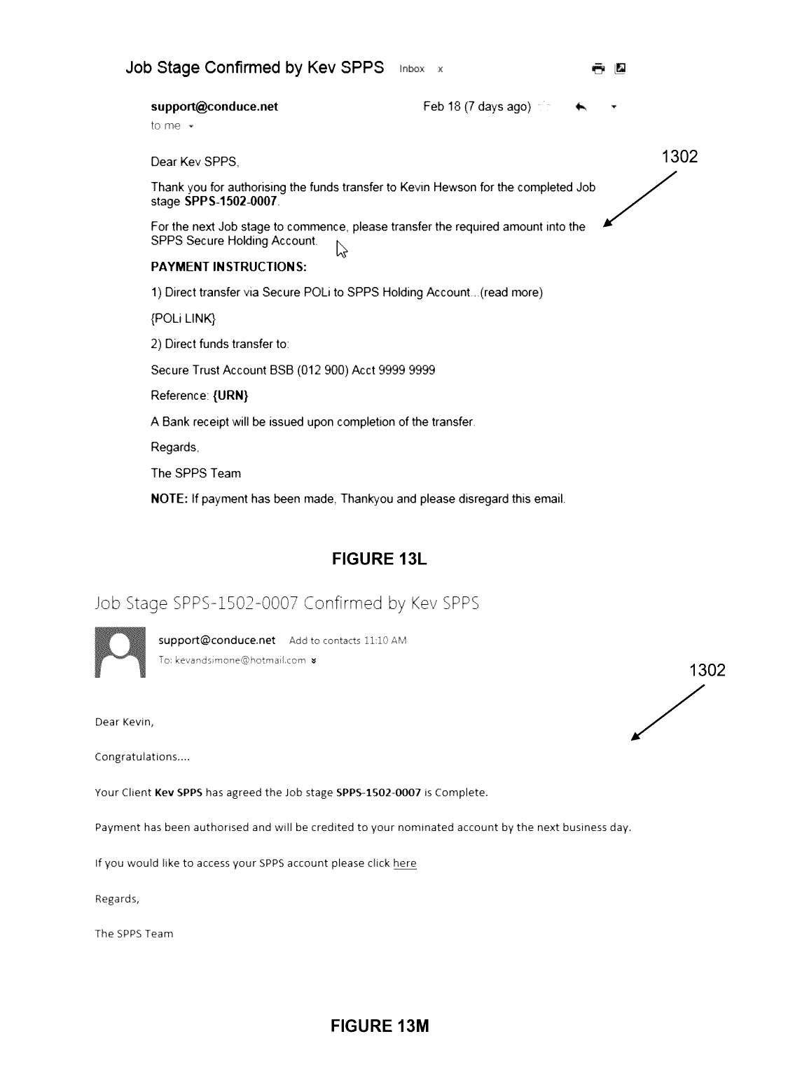

Turning now to FIG. 3, there is shown a flowchart which illustrates an exemplary method 300 of facilitating a payment transaction between a first party transaction account and a second party transaction account in accordance with the present invention. Upon starting up, the software components implementing the service either create or access the database 212, containing the transaction data, which may be stored, for example, in the non-volatile storage 110, 112. Following initialisation, the server 104 then waits for, and accepts, one or more user connections via, for example, a client device 106. This may result in generation on a display 1300 on a client device 106 (as shown in greater detail in FIGS. 13 to 16). FIG. 4 is a schematic diagram 400 illustrating the interaction of the system 100 with a first party transaction account 402 (being the transaction account of a party requiring the performance of certain services), a second party transaction account 404 (being a transaction account of a party offering to perform those services), and a holding account 406 (which is preferably facilitated and managed by a financial institution).

As is often the case in service agreements for building and construction services, a customer will engage a contractor to, for example, construct a structure and to perform the necessary services to ensure that the structure is constructed in accordance with the service agreement. As part of the service agreement, the customer and contractor will generally agree upon a fee payable to the contractor for performance of the services, as well as the various work stages (e.g. milestones) involved in completion of the services. These initial negotiation between the parties may be facilitated through the system 100, but may also occur in the traditional way through, for example, face-to-face meetings between the parties. As a result, the method 300 may include the preliminary step of receiving at the server 104 from one or more of the first party 401 and second party 403 transaction data associated with the service agreement, including at least an agreed minimum amount of funds required to be deposited into the holding account 406 before the second party 403 will commence the services specified in the service agreement.

Once the parties have agreed upon the terms and conditions of the service agreement, this information (representing further transaction data) can be input by one or more of parties via a client device 106, and stored in the database 212 for later use. For example, in one exemplary embodiment, the second party 403 (i.e. the contractor) may access the system 100 via a client device 106 and input transaction data including the name and contact details of the first party 401 (i.e. the customer), the estimated total cost of the job, details regarding the agreed job stages and the requirements for completion of those job stages, and payment percentages for each job stage. The system 100 may then be configured to send to the first party 401 via the communications network 114 a notification (such as, for example, an automated electronic notification (AEN)) that transaction data has been received by the system 100.

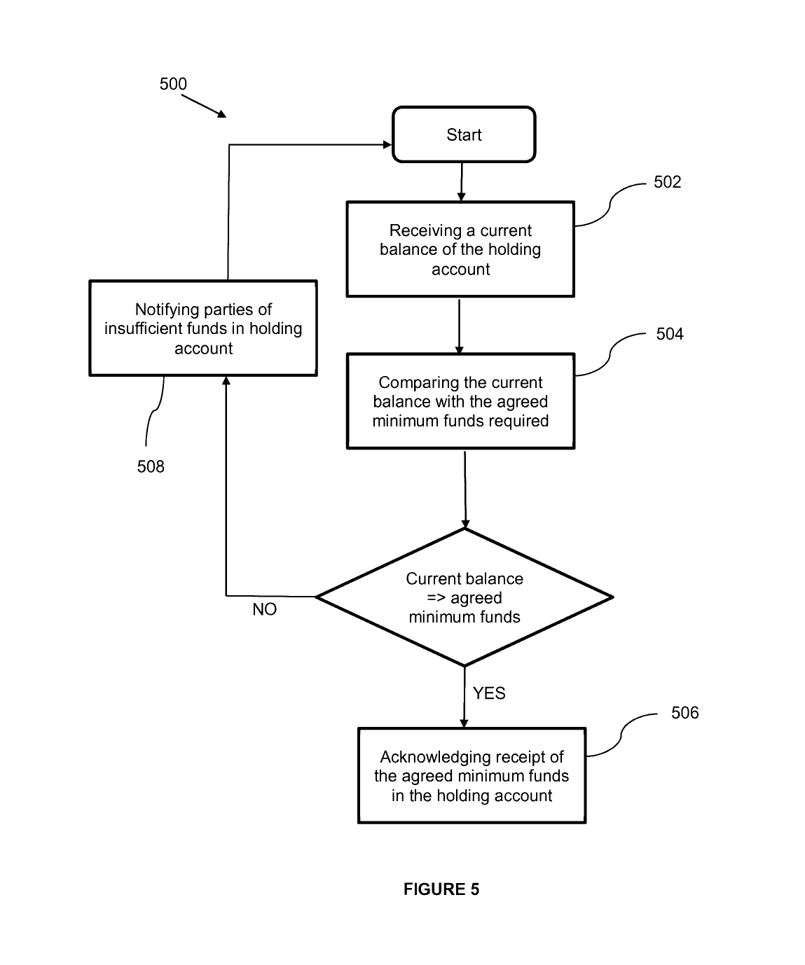

At step 302, the system 100, 200 is configured to acknowledge receipt of funds in a holding account 406. In an exemplary embodiment of the present invention, the funds received in the holding account 406 are received from the first party transaction account 402 and are preferably payable to the second party transaction account 404 (e.g. a contractor) on account of services to be provided by the second party 403 to the first party 401 (e.g. a client or customer requiring certain services to be performed) under a service agreement between the first party 401 and second party 403. In an exemplary embodiment, the step 302 may include the additional steps set out in the flowchart 500 shown at FIG. 5.

At step 502, the system 100 is configured to receive from a financial institution or facility managing the holding account 406, via the communications network 114, funds data indicative of the current balance of funds in the holding account 406. The financial institution or facility is preferably a bank or credit union, but may also be any accredited institution or facility capable of facilitating an escrow account. At step 504, the system 100 is configured to retrieve from the database 212 a funds record corresponding to the agreed minimum amount of funds required to be deposited in the holding account 406, and to compare that amount with the current balance of the holding account 406. If the current balance is equal to or greater than the agreed minimum amount of funds required to be deposited in the holding account 406, then at step 506 the system 100 acknowledges receipt in the holding account 406 of the agreed minimum amount of funds required (in which case the method 300 can progress to step 304) and updates the database 212 to mark a transaction record corresponding to the holding account 406 as containing the agreed minimum amount of funds required in the holding account 406. If the current balance is less than the agreed minimum funds required to be deposited in the holding account 406, then at step 508 the system 100 notifies the second party 403 (and/or the first party 401) that the agreed minimum amount of funds has not yet been received in the holding account 406.

At step 304, and following the confirmation that the holding account 406 contains the agreed minimum amount of funds, the system 100, 200 is configured to automatically send to the second party 403 via the communications network 114 a notification (such as, for example, an AEN) advising the second party 403 that at least the agreed minimum amount of funds have been deposited in the holding account 406. Upon receipt of this notification, preferably via a client device 106, the second party 403 (e.g. the contractor performing the services) can proceed to, for example, purchase materials necessary to complete the job, and/or engage subcontractors, and have confidence that the agreed minimum funds have been secured in the holding account 406. The second party 403 can then proceed to complete the services specified in the service agreement. It is important to note that the services specified by the parties 401, 403 in the transaction data may be grouped into a single stage, or divided into a number of consecutive stages. In the former case, the agreed minimum amount of funds required to be deposited in the holding account 406 would be for the entire job (i.e. all services specified in the service agreement). In the latter case, and according to a preferred embodiment of the present invention, the agreed minimum amount of funds required to be deposited in the holding account 406 would vary depending on the particular work stage being undertaken.

Upon completion of the services specified in the service agreement, or upon completion of a particular job stage (i.e. a subset of those services), the second party 403 (i.e. the contractor) sends via a client device 106 performance data, which includes a notification that the services (or a stage, representing a subset of those services) have been completed. At step 306, the system 100, 200 is configured to receive from the second party 403 via the communications network 114 the performance data including the notification that the services (or a stage, representing a subset of those services) have been performed. In an exemplary embodiment of the present invention, the second party 403 is also able to input as performance data, via the client device 106, additional information about the services performed in order to demonstrate that those services (or subset of those services) have been performed in accordance with the service agreement. This additional information may include comments concerning the services performed and/or photographs of the work performed (e.g. photographs of the building or construction, or relevant progress of that building or construction). Upon receipt of the performance data, the system 100 is configured to update the database 212 to mark a performance record corresponding to services specified in the service agreement as being completed by the second party 403. Step 306 of the method also encompasses the system 100 receiving at the server 104 such additional information and storing it as transaction data (or additional data) within the database 212.

At step 308, and following the receipt of performance data from the second party 403, the system 100, 200 is configured to automatically send to the first party 401 (i.e. the customer requiring performance of the services) via the communications network 114 a notification that the second party 403 (i.e. the contractor) has indicated performance of the services specified in the service agreement (or in a particular work stage of the service agreement). Where additional information has been provided by the second party 403, as performance data, to demonstrate performance of the services (or a stage, representing a subset of those services), then at step 308 the system 100, 200 will also automatically notify the first party 401 that such additional information has been provided by the second party 403. It is then possible for the first party 401 to access this additional information via the communication network 114 and using a client device 106, as a means of verifying whether the services (or a stage, representing a subset of those services) have actually been performed by the second party 403 in accordance with the service agreement. It is of course also envisaged that the first party 401 may conduct a physical inspection of the work site in order to further verify whether the services have been performed in accordance with the service agreement (e.g. to a sufficiently high level of quality and workmanship).

If the first party 401 is satisfied that the services (or a stage, representing a subset of those services) have been performed in accordance with the service agreement, the first party 401 (i.e. the customer) sends via a client device 106 a confirmatory notification that the services (or a stage, representing a subset of those services) has been completed. At step 310, the system 100, 200 is configured to receive from the first party 401 via the communications network 114 confirmatory performance data, which includes a notification that the services (or a stage, representing a subset of those services) have been performed in accordance with the service agreement. Upon receipt of the confirmatory performance data, the system 100 is configured to update the database 212 to mark a payment record corresponding to the holding account 406 as authorised to transfer the agreed minimum amount of funds from the holding account 406 to the second party transaction account 404.

At step 312, and upon receipt of the confirmatory performance data, including the notification, from the first party 401, the system 100, 200 is configured to transmit to a payment server (preferably a server managed by a financial institution that operates and facilitates the holding account 406) authorisation data to enable the transfer of at least the agreed minimum amount of funds from the holding account 406 to the second party transaction account 404. If the entirety of the funds held in the holding account 406 relate to the services (or a stage, representing a particular subset of those services) then the system 100 will transmit authorisation data authorising the transfer of all of those funds to the second party transaction account 404 (preferably by electronic funds transfer (EFT) to the second party transaction account 404 specified in the transaction data). Alternatively, if the funds held in the holding account 406 relate to more than one of the stages specified in the service agreement, and where the confirmatory performance data and notification received from the first party 401 relates to only one of those stages, then only those funds relating to the stage confirmed by the first party 401 as being completed will be transferred to the second party transaction account 404. In any event, upon authorisation of the transfer of funds to the second party transaction account 404, the system 100, 200 may be configured to automatically send to the second party 403 a notification that the funds have been transferred from the holding account 406 to the second party transaction account 404.

In the case of a service agreement involving multiple stages, the method 300 preferably repeats for each stage. In an exemplary embodiment, and upon completion of each stage (except, of course, for the final stage specified in the service agreement), the system 100, 200 may be configured to send to the first party 401 via the communications network 114 a notification that the agreed minimum amount of funds required for the next stage of the work is required to be deposited in the holding account 406 before the second party 403 can commence the services forming part of that stage.

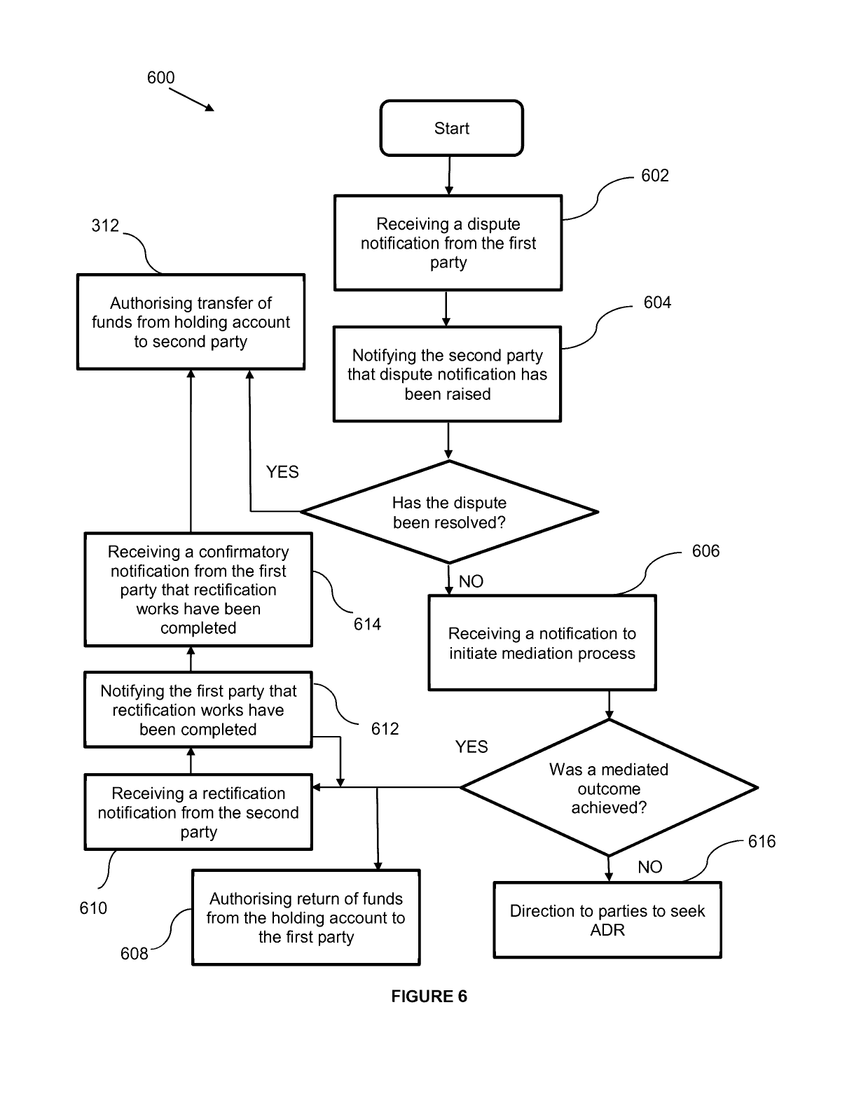

Returning to step 308, after the first party 401 receives a notification that the second party 403 has indicated performance of the services (or in a particular work stage of the service agreement), it may not always be the case that the first party 401 is satisfied that the services (or a stage, representing a particular subset of those services) have been completed in accordance with the service agreement. In such a case, instead of the first party 401 sending confirmatory performance data, including a notification that the services (or a stage, representing a subset of those services) have been completed, the first party 401 may initiate a dispute resolution process 600 illustrated by the flowchart in FIG. 6.

If the first party 401 does not consider that the services (or a stage, representing a particular subset of those services) have been completed, or completed in accordance with the services agreement (e.g. to a sufficiently high level of quality and workmanship), the first party 401 can send to the server 104, via a client device 106, dispute data including a notification that a dispute has been raised. This dispute data may additional information such as, for example, comments and/or photographs evidencing that the services (or a stage, representing a particular subset of those services) were not completed satisfactorily or in accordance with the service agreement. At step 602, the system 100, 200 is configured is to receive from the first party 401, via the communications network 114, the dispute data and notification indicating that the services (or a stage, representing a subset of those services) have not, in the opinion of the first party 401, been performed in accordance with the service agreement. Upon receipt of the dispute data, the system 100 is preferably configured to update the database 212 to mark a dispute record corresponding to particular services specified in the service agreement (or a stage, representing a particular subset of those services) as being disputed by the first party 401. Step 602 of the method also encompasses the system 100 receiving at the server 104, as dispute data, additional information (e.g. comments and/or photographs) and storing it as transaction data (or additional data) within the database 212.

At step 604, the system 100, 200 is configured to send to the second party 403 (i.e. the contractor that has performed the services) via the communications network 114 a notification that the first party 401 has raised a dispute notification and that the transfer of funds from the holding account 406 to the second party transaction account 404 has not been authorised. Where additional information (relevant to the dispute) has been provided by the first party 401 (e.g. comments and/or photographs evidencing that the services (or a stage, representing a particular subset of those services) have not been performed in accordance with the service agreement), then at step 604 the system 100, 200 will also notify the second party 403 that such additional information has been provided by the first party 401. It is then possible for the second party 403 to access this additional information via the communication network 114 and using a client device 106, as a means of potentially addressing the issues raised by the first party 401 regarding the performance of the services.

Following the receipt of the dispute notification by the second party 403, the parties may preferably engage in discussions between themselves and attempt to resolve the dispute regarding the performance of the services (or a stage, representing a particular subset of those services). If these discussions are unsuccessful then either of the parties 401, 403 can initiate a mediation process via a client device 106 (which, in an exemplary embodiment, is received by the system 100 as a request for appointment of a mediator to consider the dispute).

At step 606, and following the receipt at the server 104 of a notification to initiate a mediation process from one or more of the parties 401, 403, the system 100, 200 may be configured to allocate a mediator to consider the dispute.

Following the mediation process with the parties 401, 403, and assuming a mediated outcome can be reached between the parties 401, 403, the mediator will send via the communications network 114 determination data, including a notification regarding the result of the mediation. Upon receipt of the determination data and notification at the server 104, the system 100, 200 may be configured:
(a) at step 312, to transmit to the payment server authorisation data to enable the transfer of at least the agreed minimum amount of funds from the holding account 406 to the second party transaction account 404; or
(b) at step 608, to transmit to the payment server authorisation data to enable the return of at least a portion of the funds from the holding account 406 to the first party transaction account 402.

It should be understood that prior to transmitting to the payment server authorisation data to enable the transfer of at least the agreed minimum amount of funds from the holding account 406 to the second party transaction account 404, the mediator may require that certain aspects of the services (or a stage, representing a particular subset of those services) be rectified by the second party 403. The second party 403 would then be required to rectify those services, and to send via the communications network 114 rectification data, including a notification indicating that the required rectifications have been indicated as performed by the second party 403. At step 610, the system 100, 200 is configured to receive from the second party 403 via the communications network 114 the rectification data including the notification that the required rectifications to the services (or a stage, representing a subset of those services) have been performed.

At step 612, and following receipt of the rectification data, including the notification, from the second party 403, the system 100, 200 is configured to automatically send to the first party 401 (i.e. the customer) via the communications network 114 a notification that the second party 403 (i.e. the contractor) has indicated performance the required rectifications to the services. If the first party 401 is satisfied that the rectifications to the services (or a stage, representing a subset of those services) have been performed in accordance with the service agreement and/or the mediated outcome, the first party 401 (i.e. the customer) sends via a client device 106 confirmatory rectification data, including a notification that the rectifications to the services (or a stage, representing a subset of those services) have been completed. At step 614, the system 100, 200 is configured to receive at the server 104 from the first party 401, via the communications network 114, the confirmatory rectification data, including the notification that the rectifications to the services (or a stage, representing a subset of those services) have been completed. Upon receipt of the confirmatory rectification data, the system 100 is configured to update the database 212 to mark the dispute record corresponding to particular services specified in the service agreement (or a stage, representing a particular subset of those services) as being resolved (whereas previously this record as marked as ‘disputed’).

In this case, the system 100, 200 may be further configured at step 312, upon receipt of the confirmatory rectification data, including the notification, from the first party 401, to transmit to a payment server (preferably a server managed by a financial institution that operates and facilitates the holding account 406) authorisation data to enable the transfer of at least the agreed minimum amount of funds from the holding account 406 to the second party transaction account 404.

In the event that a mediated outcome cannot be achieved between the parties, then at step 616 the mediator may direct the parties 401, 403 to pursue the resolution of the dispute through relevant legal avenues such as, for example, State tribunals and/or courts (i.e. alternative dispute resolution (ADR)).

In the event that the first party 401 does not respond (within a pre-determined time period) to confirm that the second party 403 has performed the services (or a stage, representing a particular subset of those services), following the receipt of the notification at step 306 that the second party 403 has indicated performance of those services, the system 100, 200 may be configured to raise an alert to contact the first party (i.e. the customer) to determine whether the services (or a stage, representing a particular subset of those services) have been performed. If contact cannot be made with the first party 401 (within a further pre-determined time period) then, in an exemplary embodiment of the present invention, the system 100, 200 may be configured to proceed directly to step 312 and to transmit to the payment server authorisation data to enable the transfer of at least the agreed minimum amount of funds from the holding account 406 to the second party transaction account 404.

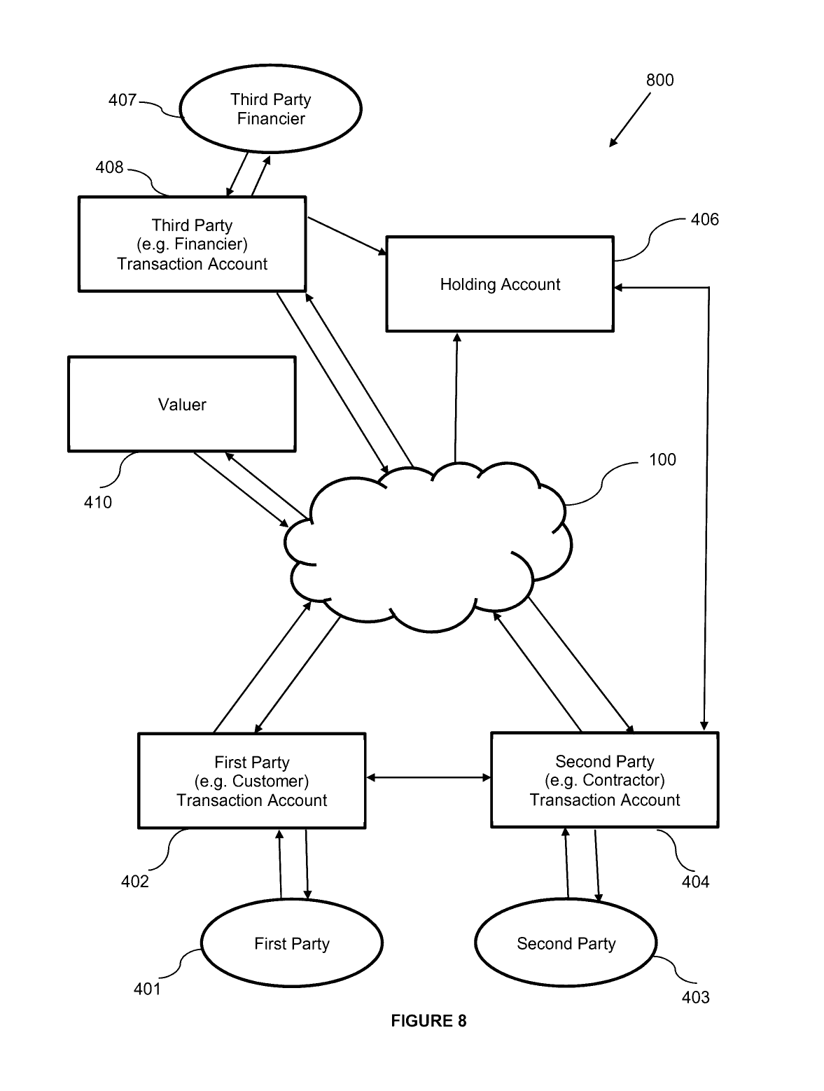

As previously discussed, at step 302, the system 100, 200 is configured to acknowledge receipt of funds in a holding account 406. In an alternate embodiment 700 of the present invention, and as illustrated in the schematic diagram 800 shown in FIG. 8, the funds held in the holding account 406 may be received from a third party transaction account 408 as a result of a pre-existing credit arrangement between the first party 401 and a third party 407 financier. For example, the funds may be forwarded to the holding account 406 by a financial institution (or similar provider or credit) on behalf of the first party 401, based on a pre-existing credit arrangement with the first party 401.

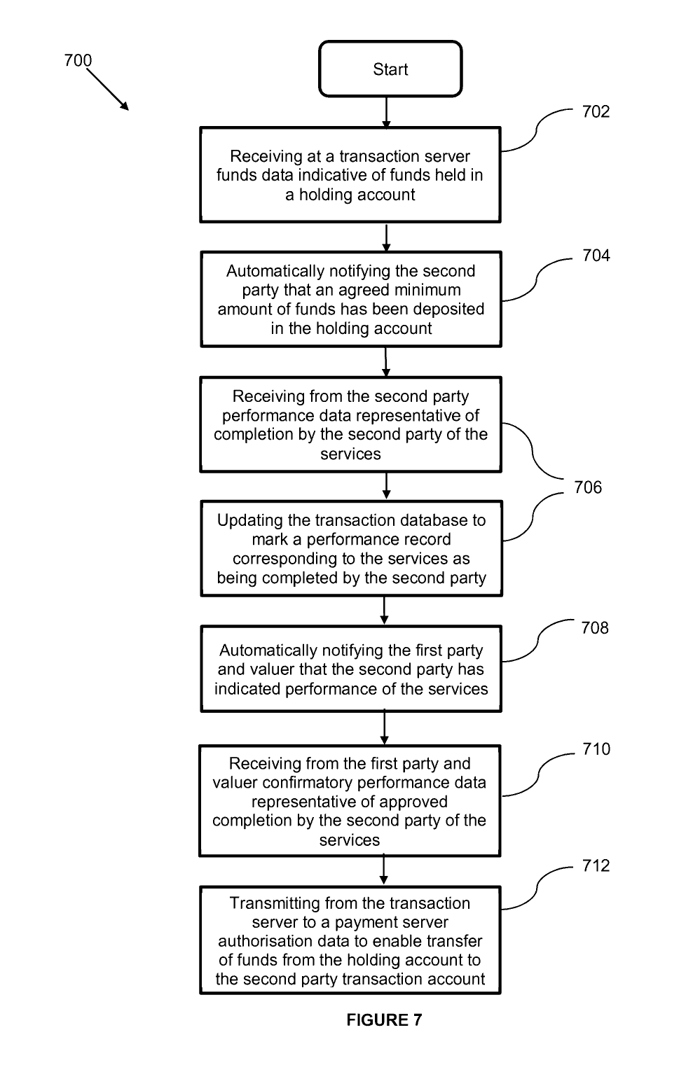

In accordance with this alternate embodiment 700, illustrated in the flowchart at FIG. 7, the transaction data entered by the second party 403 via a client device 106 may also include the contact details of the third party 407 financier, and the account details of the third party transaction account 408. The system 100 may then be configured send to the third party 407 financier via the communications network 114 a notification (such as, for example, an automated electronic notification (AEN)) that transaction data has been received by the system 100. The system 100 may also be configured to send to a valuer 410 via the communications network 114 a notification (such as, for example, an automated electronic notification (AEN)) that transaction data has been received by the system 100.

At step 702, the system 100, 200 is configured to acknowledge receipt of funds in a holding account 406. In this alternate embodiment of the present invention, the funds received in the holding account 406 are received from the third party transaction account 408 and are preferably payable to the second party transaction account 404 (e.g. a contractor) on account of services to be provided by the second party 403 to the first party 401 (e.g. a client or customer requiring certain services to be performed) under a service agreement between the first party 401 and second party 403.

At step 704, the system 100, 200 is configured to send to the second party 403 via the communications network 114 a notification (such as, for example, an AEN) advising the second party 403 that at least the agreed minimum amount of funds have been deposited in the holding account 406. Upon receipt of this notification, preferably via a client device 106, the second party 403 (e.g. the contractor performing the services) can proceed to, for example, purchase materials necessary to complete the job, and/or engage subcontractors, and have confidence that the agreed minimum funds have been secured in the holding account 406. The second party 403 can then proceed to complete the services specified in the service agreement.

Upon completion of the services specified in the service agreement, or upon completion of a particular job stage (i.e. a subset of those services), the second party 403 (i.e. the contractor) sends via a client device 106 a notification that the services (or a stage, representing a subset of those services) have been performed. At step 706, the system 100, 200 is configured to receive from the second party 403, via the communications network 114, a notification that the services (or a stage, representing a subset of those services) have been performed.

At step 708, the system 100, 200 is configured to send to the first party 401 (i.e. the customer requiring performance of the services) via the communications network 114 a notification that the second party 403 (i.e. the contractor) has indicated performance of the services specified in the service agreement (or in a particular work stage of the service agreement). Where additional information has been provided by the second party 403 to demonstrate performance of the services (or a stage, representing a subset of those services), then at step 708 the system 100, 200 will also notify the first party 401 that such additional information has been provided by the second party 403. In addition, and also at step 708, the system 100, 200 may be configured to send to the third party 407 financier via the communications network 114 a notification that the second party 403 (i.e. the contractor) has indicated performance of the services specified in the service agreement (or in a particular work stage of the service agreement), and to send to the valuer 410 via the communications network 114 a notification that the second party 403 (i.e. the contractor) has indicated performance of the services specified in the service agreement (or in a particular work stage of the service agreement) and a request for inspection of the services performed by the second party 403.

If the first party 401 and the valuer 410 are satisfied that the services (or a stage, representing a subset of those services) have been performed in accordance with the service agreement, the first party 401 (i.e. the customer) and the valuer 410 both send via a client device 106 a confirmatory notification that the services (or a stage, representing a subset of those services) have been completed. At step 710 the system 100, 200 is configured to receive from the first party 401 and from the valuer 410 via the communications network 114 a confirmatory notification that the services (or a stage, representing a subset of those services) have been performed by the second party 403 in accordance with the service agreement.

At step 712, and upon receipt of the confirmatory notification from both the first party 401 and the valuer 410, the system 100, 200 is configured to transmit to the payment server authorisation data to enable the transfer of at least the agreed minimum amount of funds from the holding account 406 to the second party transaction account 404. If the entirety of the funds held in the holding account 406 relate to the services (or a stage, representing a particular subset of those services) then the system 100 will transmit authorisation data authorising the transfer of all of those funds to the second party transaction account 404 (preferably by electronic funds transfer (EFT) to the second party transaction account 404 specified in the transaction data). Alternatively, if the funds held in the holding account 406 relate to more than one of the stages specified in the service agreement, and where the confirmatory performance data and notification received from the first party 401 relates to only one of those stages, then only those funds relating to the stage confirmed by the first party 401 as being completed will be transferred to the second party transaction account 404. In any event, upon authorisation of the transfer of funds to the second party transaction account 404, the system 100, 200 may be configured to automatically send to the second party 403 a notification that the funds have been transferred from the holding account 406 to the second party transaction account 404.

In the case of a service agreement involving multiple stages, the method 700 preferably repeats for each stage. In an exemplary embodiment, and upon completion of each stage (except, of course, for the final stage specified in the service agreement), the system 100, 200 may be configured to send to the first party 401 and to the third party 407 financier via the communications network 114 a notification that the agreed minimum funds required for the next stage of the work is required to be deposited in the holding account 406 before the second party 403 can commence the services forming part of that stage.

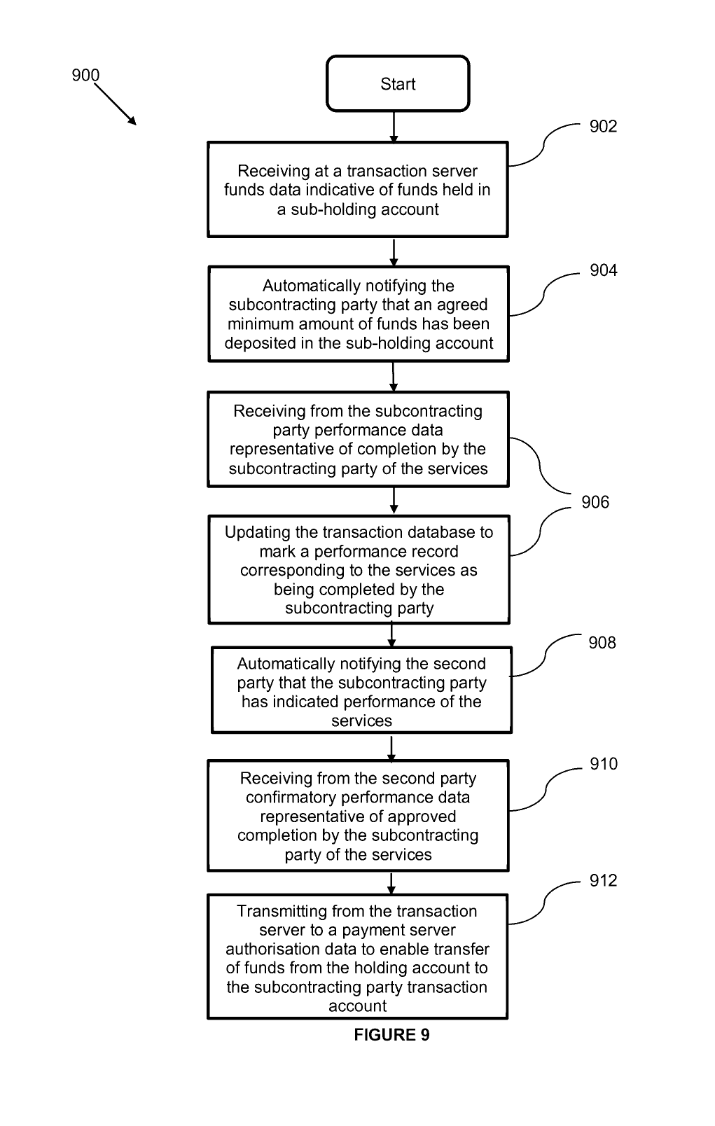

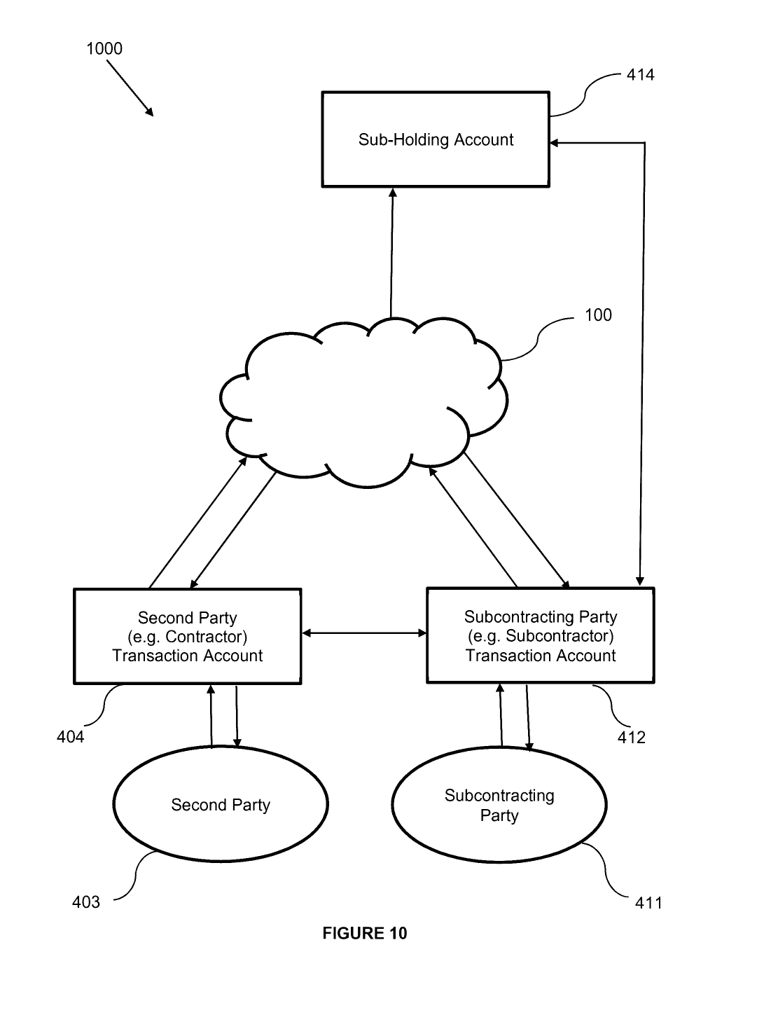

In a further exemplary embodiment 900 of the present invention, illustrated by the flowchart in FIG. 9, the method 300 may be further expanded to allow the second party 403 (i.e. the contractor) to subcontract certain of the services specified in the services agreement (e.g. a subset of those services) to subcontractors, and to allow the second party 403 to establish a sub-holding account that is separate and distinct from the holding account 406. FIG. 10 is a schematic diagram 1000 illustrating the interaction of the system 100 with the second party transaction account 404 (being a transaction account associated with a contractor subcontracting the performance of certain services), a subcontracting party transaction account 412 (being a transaction account associated with a subcontracting party offering to perform those services), and a sub-holding account 414 (which is preferably facilitated and managed by a financial institution).

The embodiment 900 operates much the same as the method 300, except that the second party 403 effectively operates as the customer (i.e. the first party 401 in method 300), and the subcontracting party 411 operates as the contractor (i.e. the second party 403 in method 300). In accordance with embodiment, and as a preliminary step, the second party 403 (i.e. the contractor) and the subcontracting party 411 will generally agree upon a fee payable to the subcontracting party 411 for performance of a subset of the services specified in the service agreement between the first party 401 and second party 403. These initial negotiation between the parties 403, 411 may be facilitated through the system 100, but may also occur in the traditional way through, for example, face-to-face meetings between the parties 403, 411. As a result, the method 900 may include the preliminary step of receiving from one or more of the second party 403 and subcontracting party 411 transaction data associated with a subset of the services, including at least a second agreed minimum amount of funds required to be deposited into the sub-holding account 414 before the subcontracting party 411 will commence the subset of services.

Once the parties 403, 411 have agreed upon the terms and conditions of performance of the subset of services, this information (representing further transaction data) can be input by one or more of parties 403, 411 via a client device 106, and stored in the database 212 for later use. For example, in one exemplary embodiment, the subcontracting party 411 (i.e. the subcontractor) may access the system 100 via a client device 106 and input transaction data including the name and contact details of the second party 403 (i.e. the contractor), the estimated total cost of the job for performing the subset of services, details regarding the agreed job stages and the requirements for completion of those job stages, and payment percentages for each job stage. The system 100 may then be configured send to the second party 403 via the communications network 114 a notification (such as, for example, an automated electronic notification (AEN)) that transaction data has been received by the system 100.

At step 902, the system 100, 200 is configured to acknowledge receipt of funds in a sub-holding account 414. In an exemplary embodiment of the present invention, the funds held in the sub-holding account 414 are received from the second party transaction account 404 and are preferably payable to the subcontracting party transaction account 412 on account of the subcontracting party 411 performing a subset of the services to be provided by the second party 403 to the first party 401 (i.e. customer) under a service agreement between the first party 401 and second party 403. In relation to authenticating the receipt of funds in the sub-holding account 414, at step 902, the system 100, 200 is preferably configured to perform additional steps as set out in the flowchart 500 shown at FIG. 5.

At step 904, the system 100, 200 is configured to automatically send to the subcontracting party 411, via the communications network 114, a notification (such as, for example, an AEN) advising the subcontracting party 411 that at least the second agreed minimum amount of funds has been deposited in the sub-holding account 414. Upon receipt of this notification, preferably via a client device 106, the subcontracting party 411 (e.g. the subcontractor performing the subset of the services) can proceed to, for example, purchase materials necessary to complete the job, and/or engage further subcontractors, and have confidence that the second agreed minimum funds have been secured in the sub-holding account 414. The subcontracting party 411 can then proceed to complete the subset of the services (as agreed between the subcontracting party 411 and the second party 403).

Upon completion of the subset of the services, the subcontracting party 411 (i.e. the subcontractor) sends, via a client device 106, performance data, including a notification that the subset of the services has been completed. At step 906, the system 100, 200 is configured to receive from the subcontracting party 411, via the communications network 114, the performance data including the notification that the subset of the services has been performed. In an exemplary embodiment of the present invention, the subcontracting party 411 is also able to input at performance data, via the client device 106, additional information about the subset of the services performed in order to demonstrate that those services (or subset of those services) have been performed. This additional information may include comments concerning the subset of the services performed and/or photographs of the work performed (e.g. photographs of the building or construction, or relevant progress of that building or construction). Upon receipt of the performance data, the system 100 is configured to update the database 212 to mark a performance record corresponding to services specified in the service agreement as being completed by the subcontracting party 411. Step 906 of the method also encompasses the system 100 receiving such additional information and storing it as transaction data (or additional data) within the database 212.

At step 908, the system 100, 200 is configured to send to the first party 401 (i.e. the ultimate customer) and/or second party 403 (i.e. the contractor), via the communications network 114, a notification that the subcontracting party 411 (i.e. the subcontractor) has indicated performance of the subset of the services. Where additional information has been provided by the subcontracting party 411 to demonstrate performance of the subset of the services, then at step 908 the system 100, 200 may also be configured to notify the first party 401 and/or second party 403 that such additional information has been provided by the subcontracting party 411. It is then possible for the first party 401 and second party 403 to access this additional information via the communication network 114 and using a client device 106, as a means of verifying whether the subset of the services has actually been performed by the subcontracting party 411. It is of course also envisaged that the first party 401 and/or second party 403 may conduct a physical inspection of the work site in order to further verify whether the subset of the services have been performed (e.g. to a sufficiently high level of quality and workmanship).

If the first party 401 and/or second party 403 is satisfied that the subset of the services has been performed, the second party 403 (i.e. the contractor) sends, via a client device 106, confirmatory performance data, including a notification that the subset of the services has been completed. At step 910 the system 100, 200 is configured to receive from the first party 401 and/or second party 403, via the communications network 114, the confirmatory performance data including the notification that the subset of the services have been performed. Upon receipt of the confirmatory performance data, the system 100 is configured to update the database 212 to mark a payment record corresponding to the sub-holding account 414 as authorised to transfer the agreed minimum amount of funds from the sub-holding account 406 to the subcontracting party transaction account 412.

At step 912, and upon receipt of the confirmatory performance data, including the notification, notification from the first party 401 and/or the second party 403, the system 100, 200 is configured to is configured to transmit to a payment server (preferably a server managed by a financial institution that operates and facilitates the sub-holding account 414) authorisation data to enable the transfer of at least the second agreed minimum amount of funds from the sub-holding account 414 to the subcontracting party transaction account 412. If the entirety of the funds held in the sub-holding account 414 relate to the subset of the services performed by the subcontracting party 411 then the system 100 will transmit authorisation data authorising the transfer of all of those funds to the subcontracting party transaction account 412 (preferably by electronic funds transfer (EFT) to the second party transaction account 412 specified in the transaction data). Alternatively, if the funds held in the sub-holding account 414 relate to more than one of the stages specified in the service agreement, and where the confirmatory performance data and notification received from the first party 401 and/or second party 403 relates to only one of those stages, then only those funds relating to the subset of services performed by the subcontracting party 411 and confirmed as being completed by the first party 401 and/or second party 403 will be transferred to the subcontracting party transaction account 412. In any event, upon authorisation of the transfer of funds to the subcontracting party transaction account 412, the system 100, 200 may be configured to automatically send to the subcontracting party 411 a notification that the funds have been transferred from the sub-holding account 414 to the subcontracting party transaction account 412.

A particular advantage of the present invention, as described in the above embodiments, is that the step 912, of transmitting from the transaction server 104 to the payment server authorisation data to enable the transfer of at least the second agreed minimum amount of funds from the sub-holding account 414 to the subcontracting party transaction account 412 is independent of and can precede the step of transmitting from the transaction server 104 to the payment server authorisation data to enable the transfer of at least the agreed minimum amount of funds from the holding account 406 to the second party transaction account 404. As such, the subcontracting party 411 can receive payment immediately upon satisfactory completion of the services performed, and does not need to wait until the second party 403 (i.e. the contractor) receives payment for services from the first party 401 (which may often be significantly delayed).

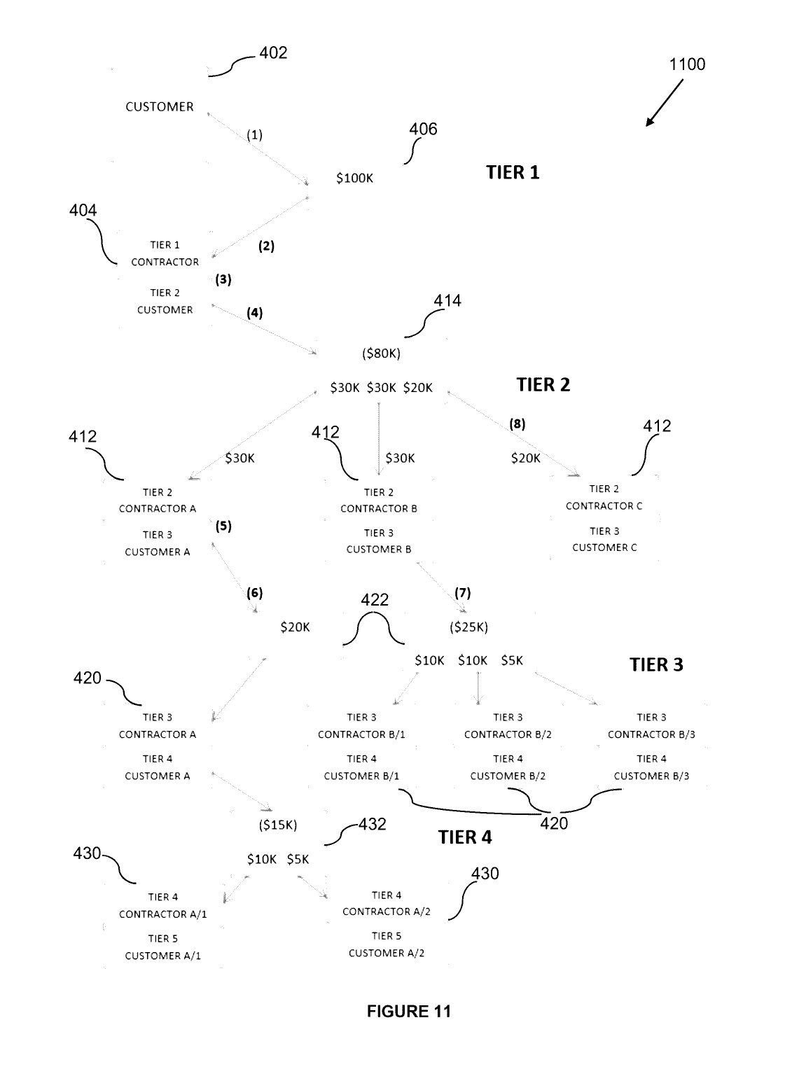

It should be appreciated from the above description of embodiment 900 that multiple subcontracting parties may be engaged by the second party 403 at the same time. Additionally, and using the same method as described above in relation to embodiment 900, the subcontracting parties (e.g. subcontracting party 411) may establish further sub-holding accounts and therefore further subcontract services. This is more clearly understood by reference to the flowchart shown in FIG. 11 which is discussed in further detail below. In addition, it should also be appreciated that the second party 403 may independently arrange deposits of funds to the sub-holding account if more than one subcontracting party 411 is to be engaged.

FIG. 11 illustrates an example 1100 of a possible contractual and sub contractual relationships between various parties to a service agreement, and demonstrates the operation of various holding 406 and sub-holding 414 accounts.

In accordance with this example 1100, a first party 401 (e.g. the initial customer) transfers $100,000 in to the holding account 406 on account of services to be provided by the second party 403 (referred to in the flowchart as the ‘Tier 1 Contractor’) under the service agreement. For the purposes of this example, the amount of $100,000 represents the agreed minimum amount of funds required to be deposited in the holding account 406 before the second party 403 will commence the services specified in the service agreement.

Upon receiving confirmation that the agreed minimum amount of funds (i.e. $100,000) has been deposited in the holding account 406, the second party 403 proceeds to seek out and engage subcontractors to perform the services specified in the service agreement. The second party 403 (now referred to in the example as ‘Tier 2 Customer’) identifies three subcontractors 411 (referred to in the example as ‘Tier 2 Contractor A’, ‘Tier 2 Contractor B’ and ‘Tier 2 Contractor C’) obtains quotations from each of these subcontractors 411 for the performance of a subset of the services specified in the service agreement. The quotations received from ‘Tier 2 Contractor A’, ‘Tier 2 Contractor B’ and ‘Tier 2 Contractor C’ are $30,000, $30,000 and $20,000 respectively. In order to engage the subcontractors 411, the second party 403 is required to transfer to a sub-holding account 414 (from a second party transaction account 404) an amount of $80,000 (representing the combined agreed minimum funds required before the ‘Tier 2 Contractor A’, ‘Tier 2 Contractor B’ and ‘Tier 2 Contractor C’ will commence the subsets of the services). Upon receipt of the $80,000 in the sub-holding account 414, the system 100 sends a notification to each of the subcontractors 411 (i.e. ‘Tier 2 Contractor A’, ‘Tier 2 Contractor B’ and ‘Tier 2 Contractor C’) advising them that the agreed minimum amount of funds have been deposited in the sub-holding account 414, so that they commence the subsets of services.

In the example 1100, one of the subcontractors 411 (referred to in the example as ‘Tier 2 Contractor A’) seeks to further subcontract the subset of services. This subcontractor 411 (now referred to in the example as ‘Tier 3 Customer A’) obtains a quotation of $20,000 from a tier 3 subcontractor 419 (referred to in the example as ‘Tier 3 Contractor A’) to perform all or part of the same subset of services for which the subcontractor 411 (i.e. ‘Tier 2 Contractor A’) was engaged to perform. In order to engage the tier 3 subcontractor 419 (referred to in the example as ‘Tier 3 Contractor A’), the subcontractor 411 (now referred to in the example as ‘Tier 3 Customer A’) is required to transfer to a tier 3 sub-holding account 422 an amount of $20,000 (representing the agreed minimum amount of funds required before the ‘Tier 3 Contractor A’ will commence the subsets of the services). Upon receipt of the $20,000 in the tier 3 sub-holding account 422, the system 100 sends a notification to the tier 3 subcontractor 419 (i.e. ‘Tier 3 Contractor A’) advising the tier 3 subcontractor 419 that the agreed minimum funds have been deposited in the tier 3 sub-holding account 422, so that they commence the subset of services. It is also understood by the tier 3 subcontractor 419 that they will receive payment from the subcontractor 411 (by way of authorised transfer of funds, in the amount of $20,000, from the tier 3 sub-holding account 422 to the tier 3 subcontractor transaction account 420) as soon as they have satisfactorily completed the services for which they were engaged. In other words, the transfer of funds from the tier 3 sub-holding account 422 to the tier 3 subcontractor transaction account 420 is independent of and can precede the transfer of funds from the sub-holding account 414 to the subcontracting party transaction account 412. Similarly, the transfer of funds from the tier 3 sub-holding account 422 to the tier 3 subcontractor transaction account 420 is independent of and can precede the transfer of funds from the holding account 406 to the second party transaction account 404 (i.e. the transaction account of the initial contractor).

Also in the example 1100, one of the subcontractors 411 (referred to in the example as ‘Tier 2 Contractor B’) seeks to further subcontract the subset of services. This subcontractor 411 (now referred to in the example as ‘Tier 3 Customer B’) obtains quotations of $10,000, $10,000 and $5,000 from three tier 3 subcontractors 419 (referred to in the example as ‘Tier 3 Contractor B/1’, ‘Tier 3 Contractor B/2’, and ‘Tier 3 Contractor B/3’ respectively) to collectively perform all or part of the same subset of services for which the subcontractor 411 (i.e. ‘Tier 2 Contractor B’) was engaged to perform. In order to engage the tier 3 subcontractors 419 (referred to in the example as ‘Tier 3 Contractor B/1’, ‘Tier 3 Contractor B/2’, and ‘Tier 3 Contractor B/3’), the subcontractor 411 (now referred to in the example as ‘Tier 3 Customer B’) is required to transfer to a tier 3 sub-holding account 422 (from the tier 3 subcontractor transaction account 420) an amount of $25,000 (representing the combined agreed minimum funds required before the ‘Tier 3 Contractor B/1’, ‘Tier 3 Contractor B/2’, and ‘Tier 3 Contractor B/3’ will commence the subsets of the services). Upon receipt of the $25,000 in the tier 3 sub-holding account 422, the system 100 sends a notification to the tier 3 subcontractors 419 (i.e. ‘Tier 3 Contractor B/1’, ‘Tier 3 Contractor B/2’, and ‘Tier 3 Contractor B/3’) advising the tier 3 subcontractors 419 that the agreed minimum amount of funds have been deposited in the tier 3 sub-holding account 422, so that they commence the subset of services.

Finally, in the example 1100, one of the tier 3 subcontractors 419 (referred to in the example as ‘Tier 3 Contractor A’) seeks to further subcontract the subset of services. This tier 3 subcontractor 419 (now referred to in the example as ‘Tier 4 Customer A’) obtains quotations of $10,000 and $5,000 from two tier 4 subcontractors 429 (referred to in the example as ‘Tier 4 Contractor A/1’ and ‘Tier 4 Contractor A/2’ respectively) to collectively perform all or part of the same subset of services for which the tier 3 subcontractor 419 (i.e. ‘Tier 3 Contractor A’) was engaged to perform. In order to engage the tier 4 subcontractors 429 (referred to in the example as ‘Tier 4 Contractor A/1’ and ‘Tier 4 Contractor A/2’), the tier 3 subcontractor 419 (now referred to in the example as ‘Tier 4 Customer A’) is required to transfer to a tier 4 sub-holding account 432 an amount of $15,000 (representing the combined agreed minimum funds required before the ‘Tier 4 Contractor A/1’ and ‘Tier 4 Contractor A/2’ will commence the subsets of the services). Upon receipt of the $15,000 in the tier 4 sub-holding account 432, the system 100 sends a notification to the tier 4 subcontractors 429 (i.e. ‘Tier 4 Contractor A/1’ and ‘Tier 4 Contractor A/2’) advising the tier 4 subcontractors 429 that the agreed minimum funds have been deposited in the tier 4 sub-holding account 432, so that they commence the subset of services.

It is also understood by the tier 4 subcontractors 429 that they will receive payment from the tier 3 subcontractor 419 (by way of authorised transfer of funds, in the respective amounts of $10,000 and $5,000, from the tier 4 sub-holding account 432 to the tier 4 subcontractor transaction accounts 430) as soon as they have satisfactorily completed the services for which they were engaged. In other words, the transfer of funds from the tier 4 sub-holding account 432 to the tier 4 subcontractor transaction accounts 430 is independent of and can precede the transfer of funds from the tier 3 sub-holding account 422 to the tier 3 subcontractor transaction account 420. Similarly, the transfer of funds from the tier 4 sub-holding account 432 to the tier 4 subcontractor transaction account 430 is independent of and can precede the transfer of funds from the sub-holding account 414 to the subcontracting transaction account 412. Similarly again, the transfer of funds from the tier 4 sub-holding account 432 to the tier 4 subcontractor transaction account 430 is independent of and can precede the transfer of funds from the holding account 406 to the second party transaction account 404 (i.e. the transaction account of the initial contractor).

As described above with reference to embodiment 700, and having regard to the example 1100, it should be appreciated that similar credit arrangements can be engaged in between the third party 407 financier and one or more of the subcontracting party 411, the tier 3 subcontractor 419 and the tier 4 subcontractor 429 (and so). If one of more of those parties 411, 419, 429 is seeking to provide the agreed minimum amount of funds (in the sub-holding account 414, tier 3 sub-holding account 422, or tier 4 sub-holding account 432 respectively) using credit finance then the steps generally described in method 700 will be followed.

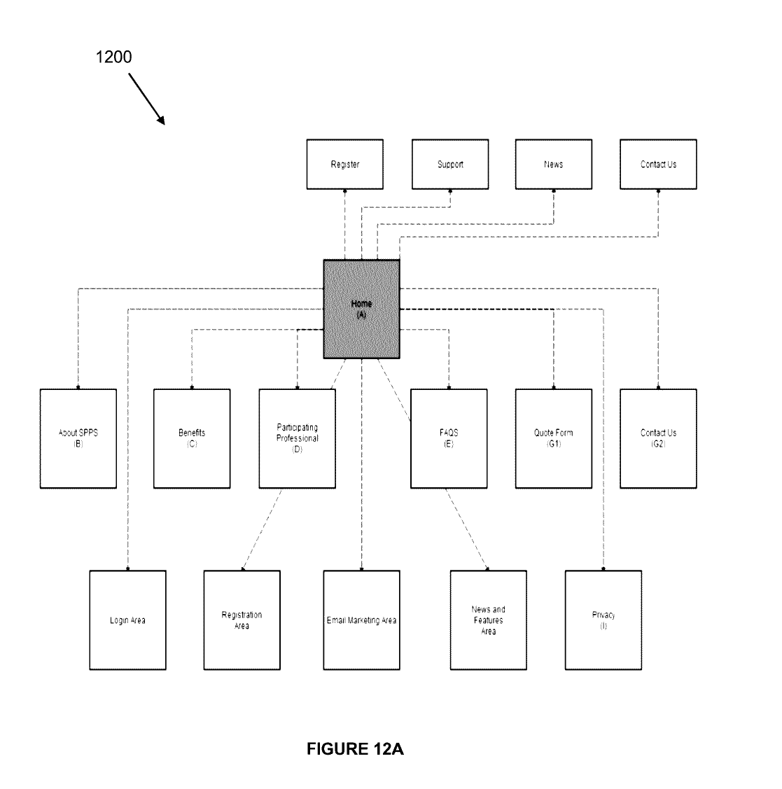

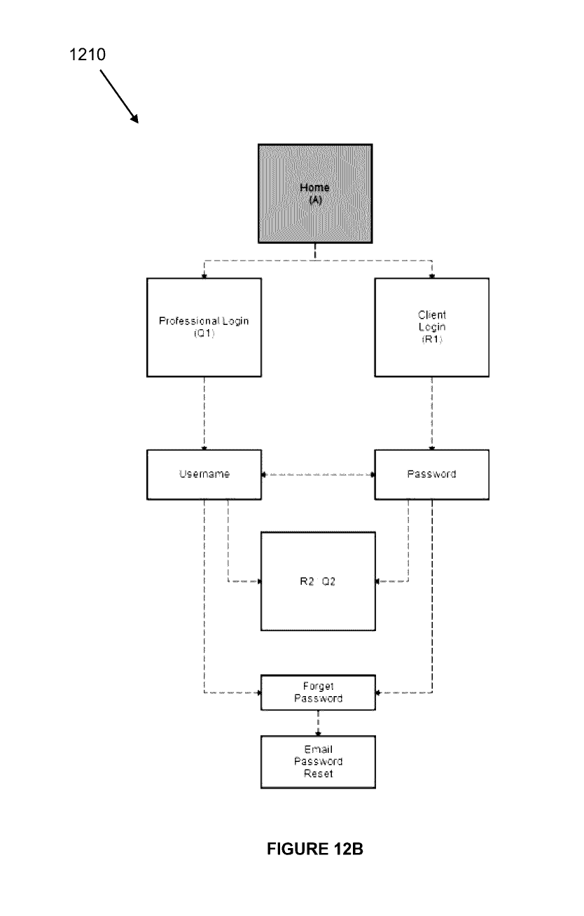

FIG. 12A is a flow diagram 1200 illustrating a site map 1200 of a web-based implementation of a system 200 of facilitating a payment transaction. FIG. 12B is a flow diagram 1210 illustrating two separate login streams that may be utilised by parties to a payment transaction in accordance with the web-based implementation of the system shown in FIG. 12A.

FIGS. 13A to 13M show a series of screenshots illustrating the functionality of a web-based implementation of a system 200 of facilitating a payment transaction in accordance with a representative embodiment of the present invention.

On the homepage of the website 1300 (accessible to the parties via a client device 106), shown at FIG. 13A, a user (i.e. either the first party 401 or second party 403) logs into either the customer or contractor stream (via the display shown at FIG. 13B). At FIG. 13C, and after logging in to the system 200, the display 1302 shows the open jobs available to a contractor 403. The display 1302 illustrated in FIG. 13C shows, by way of example only, jobs posted by four different clients, namely Forrest, Jones, Smith and SPPS.

FIG. 13D is an example screenshot that shows on the display 1302 a page permitting a contractor 403 to add a new job. The contractor 403 completes details including the job title, job post code, client's 401 name, client's 401 email, and the quoted amount for the job. The contractor 403 may also be required to answer a number of questions in relation to the job (as shown at FIG. 13D). For example, if the contractor's 403 answer to the question “Is a retainer required for this job?” is ‘yes’ then several additional data fields may be presented on the display 1302 for the contractor 403 to complete, including the retainer amount (i.e. the minimum amount of funds required before the contractor 403 will commence the job) and length of time the retainer is to be held after completion of the job. The contractor 403 is also required to complete each of the stage descriptions for the job (assuming the job is to be divided into stages), and to enter the funds payable upon completion of each stage (such as shown in FIG. 13E).

FIG. 13F is an example email notification issued by the system 200 and received by the client (customer 401) on a display 1302 of a client device 106, setting out the quote provided by the contractor 403. The email details the contractor 403 and client (customer 401) names, the job numbers, the job stages, whether finance or a retainer is required, the progress payments (if applicable) and the percentage of the total amount that each progress payment represents. It also provides details of the holding account 406 to allow the customer 401 to make the deposit of the progress payment (i.e. the agreed minimum funds required before the contractor 403 will commence the job). The client (customer 401) can access the homepage 1300 via a client device 106 and select the client stream of the system 200. Prior to receiving the deposit of funds in the holding account 406, the client stages are listed with the status “Pay Deposit”. After the deposit of funds has been made to the holding account 406 (i.e. the agreed minimum funds required before the contractor 403 will commence the job), the system 200 is configured to unlock a specific stage of the job, and to notify the contractor 403 (via an AEN) that the agreed minimum funds have been deposited in the holding account 406 and that the work can commence on the job stage.

When the contractor 403 completes the job stage, the contractor 403 accesses the system 200 via a client device 106 and selects the contractor stream of the system 200. FIG. 13G is an example screenshot that shows on the display 1302 the job stage progression page visible to the contractor 403. It is clear from this screenshot that the page shows two red crosses indicating that stage 1 has not yet been approved by either party (i.e. the customer 401 or the contractor 403). The contractor 403 can then input to the system 200 that they have completed stage 1 by clicking on the stage 1 box and, if necessary, adding comments or photographs to demonstrate completion of stage 1. FIG. 13H is an example screenshot that shows on the display 1302 a page allowing the contractor 403 to confirm the details that have been entered via a client device 106 to confirm completion of stage 1.

FIG. 13I is an example email notification issued by the system 200 and received by the customer 401 on a display 1302 of a client device 106, confirming that the contractor 403 has completed stage 1. The email notification may also request the customer 401 to access the system 200 and to confirm whether that job stage is in fact complete, or to provide comments (and/or photographs) to support the needs for certain rectification works by the contractor 403.

FIG. 13J is an example screenshot that shows on the display 1302 an open job page in the customer stream of the website 1300. The page indicates that the customer 401, has two open jobs, one to construct a new deck and the other to replace windows. FIG. 13K is an example screenshot that shows on the display 1302 a job stage progression page that is visible to the customer 401 that has registered the Job number: SPPS-1502-0007. A green tick for the contractor (i.e. professional) 403 field appears under stage 1 (for Job number: SPPS-1502-0007), indicating that the contractor 403 has confirmed completion of this stage. A red cross appears next to the client 401 field (for Job number: SPPS-1502-0007), indicating that stage 1 completion has not yet been approved by the customer 401. Once this field has been checked by the customer 401 (i.e. confirming that the contractor 403 has performed the services) the red cross will change to a green tick.

FIG. 13L is an example email notification issued by the system 200 and received by the customer 401 on a display 1302 of a client device 106, requesting payment of stage 2 funds for Job number: SPPS-1502-0007 into the holding account 406. The email provides the customer 401 with details of the holding account 406 to facilitate payment of funds into that holding account 406.

FIG. 13M is an example email notification issued by the system 200 and received by the contractor 403 on a display 1302 of a client device 106, confirming that the customer 401 has confirmed the completion of stage 1 (i.e. Job number: SPPS-1502-0007), that release from the holding account 406 of the funds (relating to Job number: SPPS-1502-0007) has been authorised, and that payment will be made shortly into the second party transaction account 404 (i.e. the transaction account of the contractor).

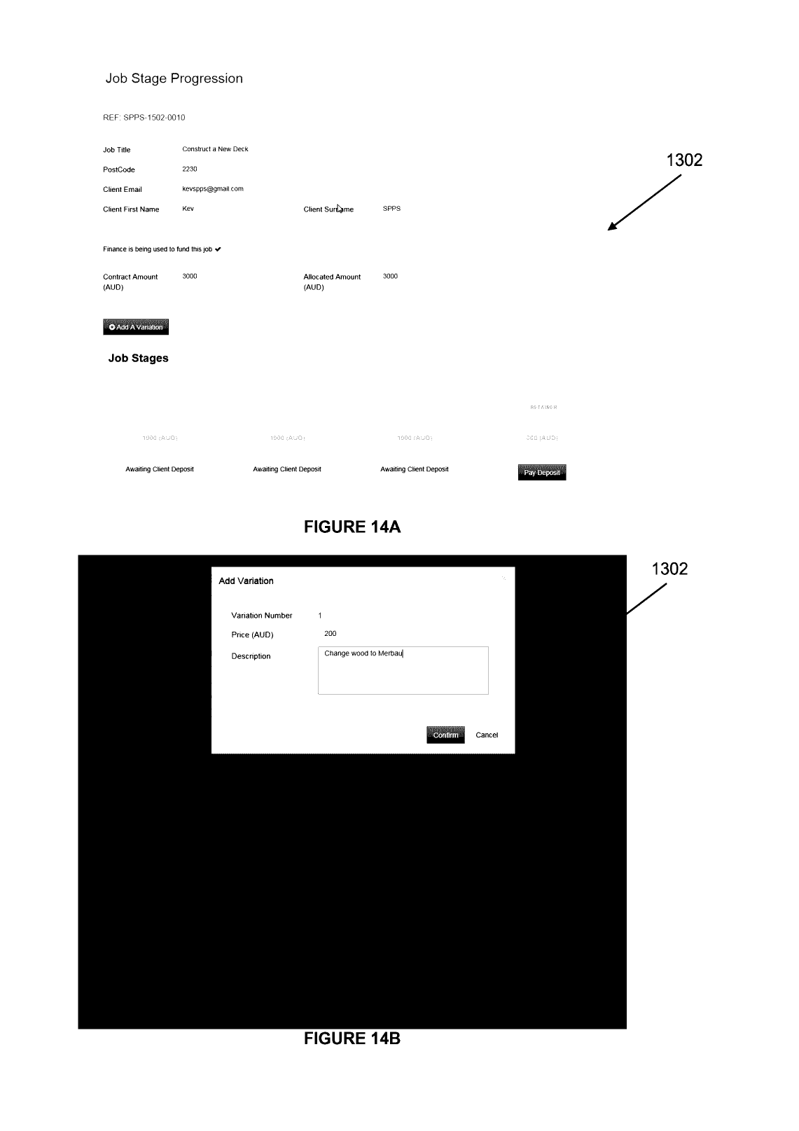

FIGS. 14A to 14B show a series of screenshots illustrating the ‘Add a Variation’ functionality of a web-based implementation of a system of facilitating a payment transaction. From the homepage of the website 1300, the contractor 403 can access the system 200 via a client device 106 and select the contractor stream of the system 200. The contractor 403 can then access their open jobs. FIG. 14A is an example screenshot that shows on the display 1302 a job stage progression page permitting a contractor 403 to add a variation to a job or job stage. The contractor 403 completes details of the new variation by providing a description and the quoted amount for the variation, and confirms these details (in a similar manner as previously described).

Once the variation stage is confirmed by the contractor 403 (as shown at FIG. 14B), an automatic email notification is sent to the customer 401 outlining the job summary, the variation and provisions, and a payment request (to the holding account 406) in relation to the variation. The variation stage is then locked as “awaiting client deposit” after details are confirmed by the contractor 403.

The variation stage is accepted once the customer 401 pays the variation amount into the holding account 406 (from the first party transaction account 402), which unlocks the variation stage. It should be understood that multiple variation stages can be entered over the course of a job.

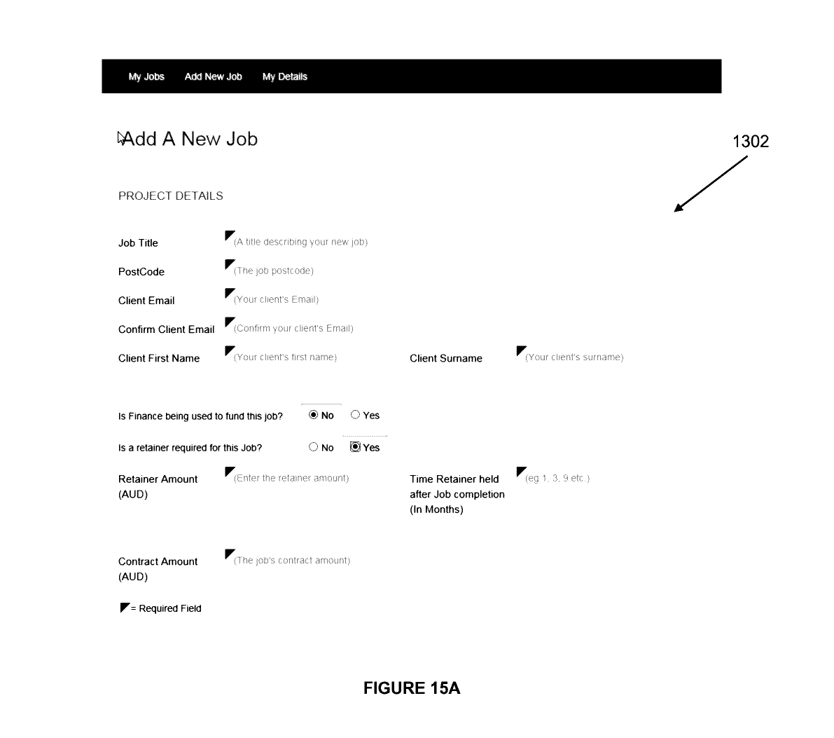

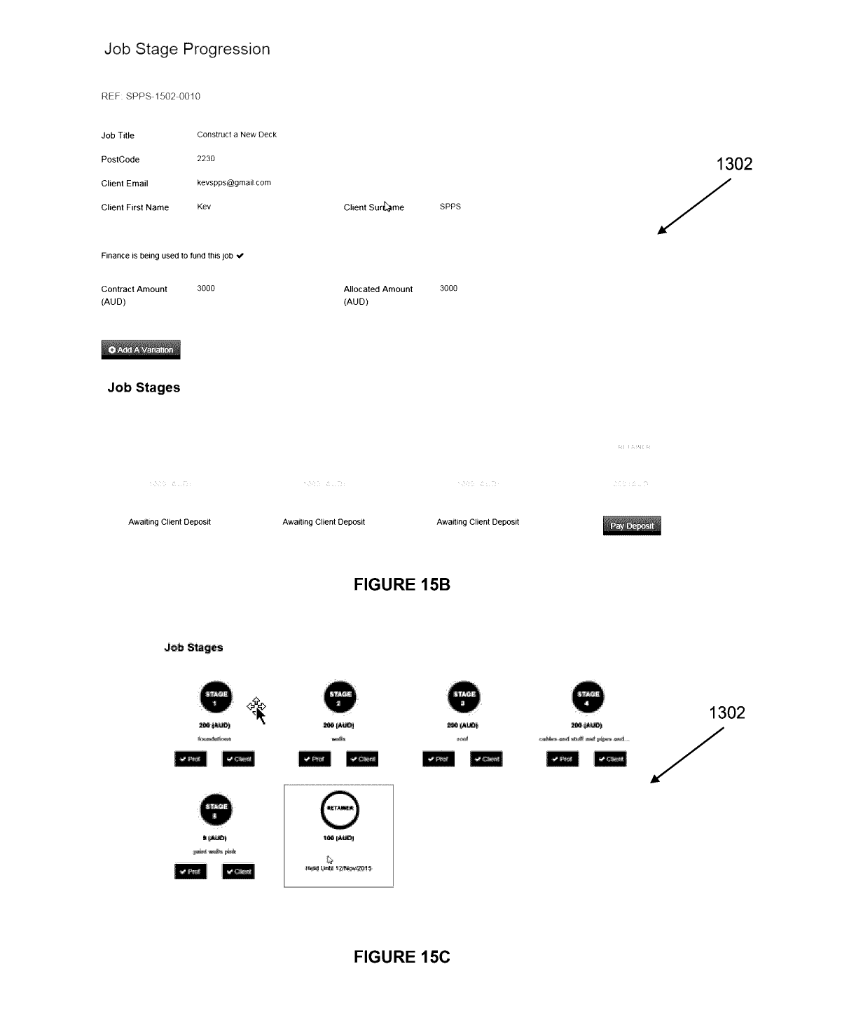

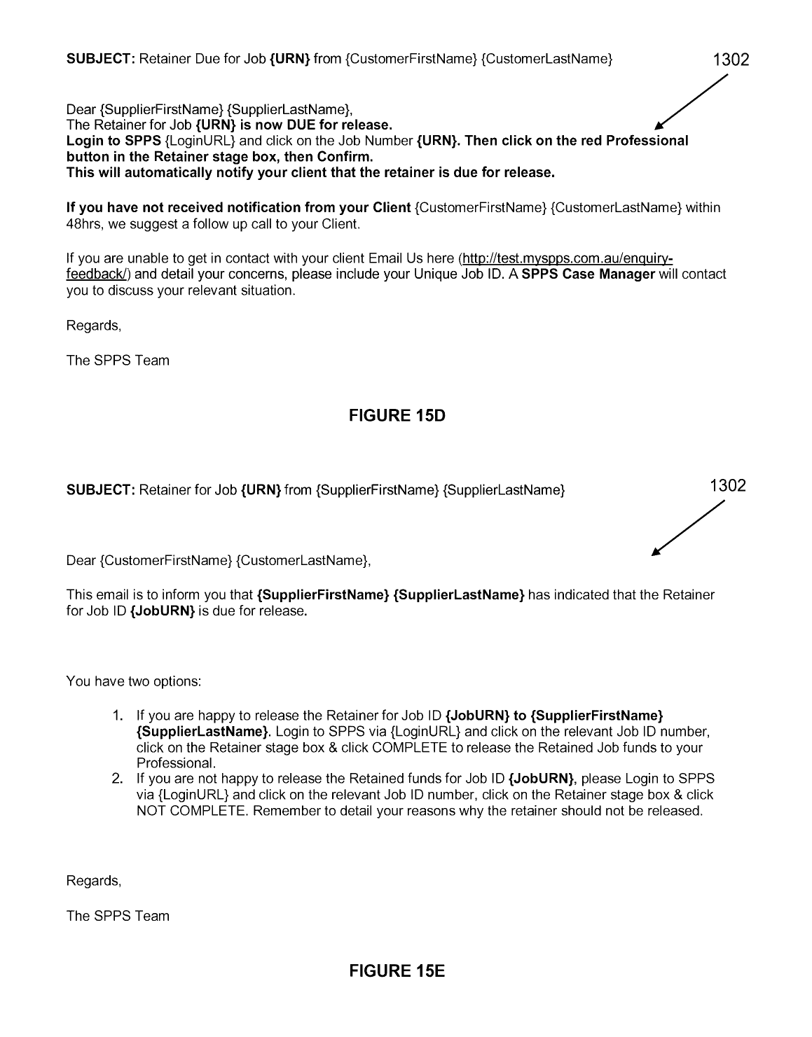

FIGS. 15A to 15E show a series of screenshots illustrating the ‘Retainer’ functionality of a web-based implementation of a system of facilitating a payment transaction. FIG. 15A is an example screenshot that shows on the display 1302 a page permitting a contractor 403 to specify and enter a retainer amount (i.e. the agreed minimum funds required to be deposited in the holding account 406 before the contractor 403 will commence the work). In many construction contracts, the contractor 403 pays a retainer in order to ensure that the job is good for a certain time. FIG. 15B is an example screenshot that shows on the display 1302 a page where the retainer stage is listed as “Pay Deposit” after details are confirmed by the contractor 403. Once the contractor 403 pays the required retainer stage deposit to the holding account 406 (from the second party transaction account 404) the retainer is held until the nominated retainer release date (as shown in FIG. 15C).

When the nominated retainer release date is reached, an email notification (an example of which is shown in FIG. 15D) is sent to the contractor 403 requesting them to click on the red button in the “Retainer” stage box (on the website 1300). This action activates the same process as when contractor 403 clicks the normal red job stage box (to turn green) when the job stage is completed. This action also automatically sends an email notification (an example of which is shown in FIG. 15E) requesting the customer 401 to confirm acceptance of this process.

If the customer 401 clicks ‘not satisfied’ then the normal process listed above in FIG. 6 applies until customer 401 is satisfied (or a mediated outcome is reached). Once the customer 401 is satisfied, they click on the green button, and the retained funds held in the holding account 406 are released to the second party transaction account 404 (i.e. the transaction account of the contractor).

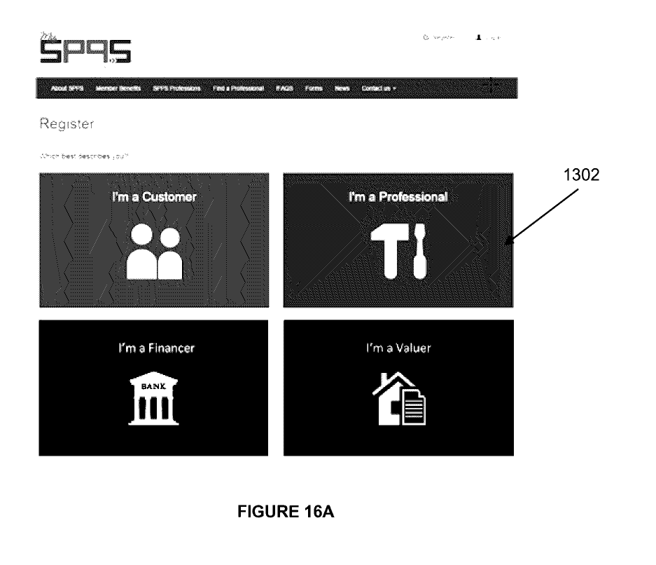

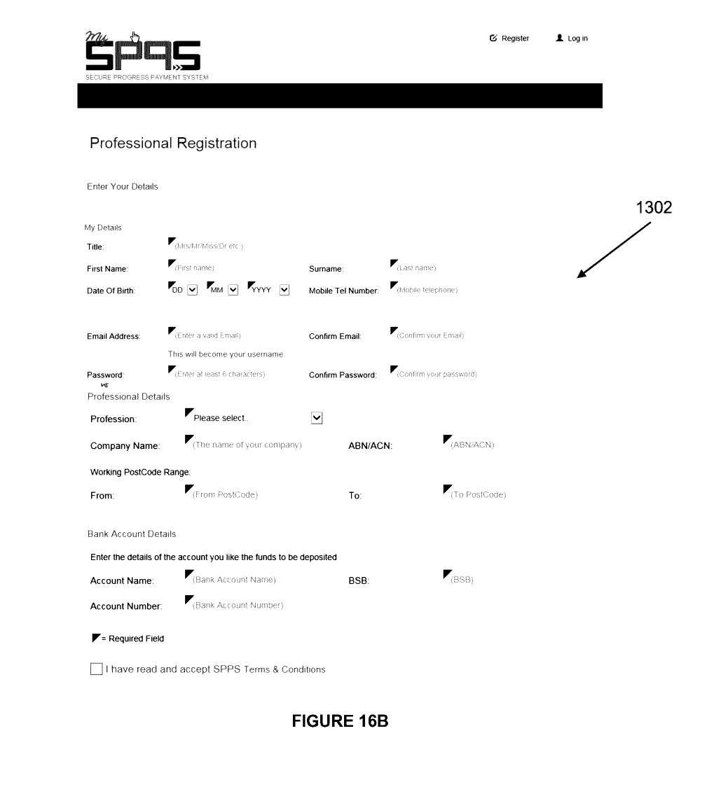

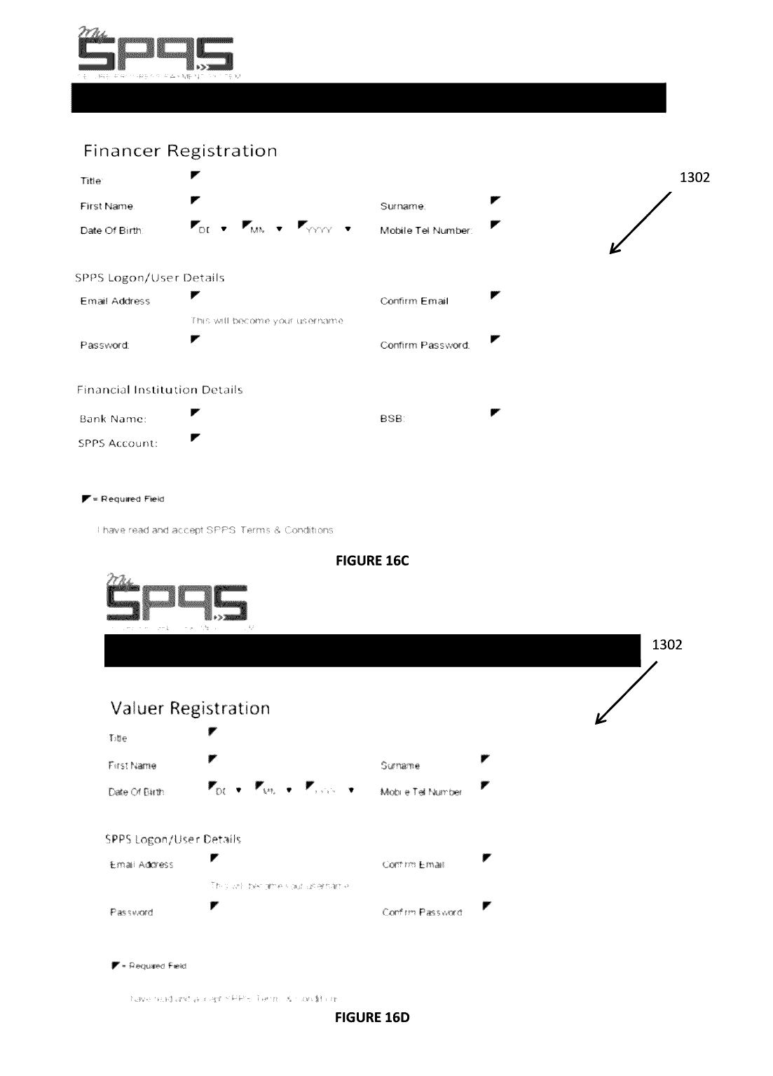

FIGS. 16A to 16F show a series of screenshots illustrating the ‘Bank Finance Module’ functionality of a web-based implementation of a system of facilitating a payment transaction. As described above in detail with reference to embodiment 700, and as shown in the flowchart in FIG. 7, the system 200 may be configured to integrate with and cater for bank finance agreements and arrangements. These are commonly required, for example, during jobs requiring construction loans. The addition of a financier (i.e. third party 407 financier) involves updating the job with the details of the loan finance being utilised, allowing a third party 407 financer to overview the jobs they are providing loans for, and also allowing a valuer 410 to be involved to inspect and certify the project on completion of each stage.

FIG. 16A is an example screenshot that shows on the display 1302 a registration screen. In the ‘Bank Finance Module’ stream of system 200, two extra buttons/panels are provided to enable third party 407 financiers and valuers 410 to register.

FIG. 16B is an example screenshot that shows on the display 1302 an example of the contractor 403 (also referred to as the ‘professional’) registration screen. FIG. 16C is an example screenshot that shows on the display 1302 an example of the third party 407 financier registration screen. FIG. 16D is an example screenshot that shows on the display 1302 a simple screen required to register the valuer 410.

When a contractor 403 creates a ‘New Job’, in addition to attaching the work details to a customer 401, they can also attach the ‘New Job’ to a third party 407 financier. The bank finance and contact details can be added when setting up a new job. The financier email only becomes required if the question “Is your client using bank finance to pay for this job?” is ticked as yes.

When a contractor 403 creates a new job and includes a third party 407 financier email, the respective banker receives an AEN (such as, for example, an email message) inviting them to register on the system 200. The third party 407 financier clicks on the link in the email and is guided through the registration process, in the same manner as when a contractor 403 invites a customer 401 to register on the system 200. The third party 407 financier may already be registered with system 200 and, if so, will only need to be informed of the new job. At this stage the potential third party 407 financier is not required to do anything, as they are just being invited to register and to provide the job finance as and when required. An example of the financer registration screen is shown in FIG. 16C.

If finance is agreed then the third party 407 financier will log into the job and make the stage 1 payment to holding account 406 (from the third party transaction account 408), they will also nominate the valuer 410 for the job. When the job is complete and the valuer 410 has certified the work, the third party 407 financier is required to approve the payment from the holding account 406 to the second party transaction account 404. The third party 407 financier can access the system 200 in order to view/manage the jobs they are financing including confirming payment details.

Having regard to the various embodiments described above, it should also be appreciated that the system 100, 200 may be configured to allow one or more of the parties (e.g. first party 401, second party 403, third party 407 financier, or subcontracting party 411) to upload via the communications network 114 an electronic copy of the service agreement. The system 100, 200 may also be configured to store the electronic copy of the service agreement in the database 212 and to facilitate access by the parties to the electronic copy of the service agreement upon request (e.g. by presentation of the electronic copy of the service agreement on a client device 106).

The word ‘comprising’, and forms of the word ‘comprising’, when used in this specification is taken to specify the presence of stated features, integers, steps or components but does not preclude the presence or addition of one or more other features, integers, steps, components or groups thereof.

As the present invention may be embodied in several forms without departing from the essential characteristics of the invention, it should be understood that the above described embodiments should not be considered to limit the present invention but rather should be construed broadly. Various modifications, improvements and equivalent arrangements will be readily apparent to those skilled in the art, and are intended to be included within the spirit and scope of the invention. The present embodiments are, therefore, to be considered in all respects as illustrative and not restrictive.

1. A computer-implemented method of facilitating a payment transaction between a first party transaction account and a second party transaction account, the method comprising:
(a) receiving at a transaction server funds data indicative of funds held in a holding account, the funds held in the holding account being received from the first party transaction account and being payable to the second party transaction account on account of services to be provided by a second party to a first party under a service agreement;
(b) automatically notifying the second party, via a communications network, that an agreed minimum amount of funds has been deposited in the holding account;
(c) receiving from the second party, via the communications network, performance data representative of completion by the second party of services specified in the service agreement;
(d) updating a transaction database to mark a performance record corresponding to services specified in the service agreement as being completed by the second party;
(e) automatically notifying the first party, via the communications network, that the second party has indicated performance of the services specified in the service agreement;
(f) receiving from the first party, via the communications network, confirmatory performance data representative of approved completion by the second party of services specified in the service agreement; and
(g) transmitting from the transaction server to a payment server authorised to action transactions from the holding account, via the communication network, authorisation data to enable the transfer of at least the agreed minimum amount of funds from the holding account to the second party transaction account.

2. The computer-implemented method according to claim 1, wherein step (a) comprises one or more of the following steps:
receiving at the transaction server from the first party and/or the second party, via the communications network, transaction data that includes the agreed minimum amount of funds required to be deposited in the holding account;
updating the transaction database to store the agreed minimum amount of funds required to be held in the holding account in a funds record;
retrieving from the transaction database the funds record corresponding to the agreed minimum amount of funds required to be held in the holding account before the second party will commence the services specified in the service agreement;
comparing the funds data with the funds record corresponding to the agreed minimum amount of funds required to be held in the holding account to determine whether the funds held in the holding account represent at least the agreed minimum amount of funds required to be held in the holding account; and
updating the transaction database to mark a transaction record corresponding to the holding account as containing an agreed minimum amount of funds.

3. The computer-implemented method according to claim 2, further comprising the step of associating the agreed minimum amount of funds with the funds record in the transaction database corresponding to the agreed minimum amount of funds required to be held in the holding account.

4. The computer-implemented method according to claim 1, wherein at least a portion of the funds held in the holding account are received from the first party transaction account.

5. The computer-implemented method according to claim 1, wherein at least a portion of the funds held in the holding account are received from a third party transaction account as a result of a pre-existing credit arrangement between the first party and a third party finance provider.

6. The computer-implemented method according to claim 1, wherein the holding account is facilitated by a financial institution or third-party transaction service provider and managed by the payment server.

7. The computer-implemented method according to claim 1, further comprising:
receiving at the transaction server funds data indicative of funds held in a sub-holding account, the funds held in the sub-holding account being received from a further second party transaction account and being payable to a subcontracting party transaction account on account of a subset of the services to be provided by a subcontracting party to the second party;
automatically notifying the subcontracting party, via a communications network, that a second agreed minimum amount of funds has been deposited in the sub-holding account;
receiving from the subcontracting party, via the communications network, performance data representative of completion by the subcontracting party of the subset of the services;
updating the transaction database to mark a performance record corresponding to services specified in the service agreement as being completed by the subcontracting party;
automatically notifying the first party and/or the second party, via the communications network, that the subcontracting party has indicated performance of the subset of the services;
receiving from the first party and/or the second party, via the communications network, confirmatory performance data representative of approved completion by the subcontracting party of the subset of the services; and
transmitting from the transaction server to a payment server authorised to action transactions from the sub-holding account, via the communication network, authorisation data to enable the transfer of at least the second agreed minimum amount of funds from the sub-holding account to the subcontracting party transaction account.

8. The computer-implemented method according to claim 9, comprising one or more of the following preliminary steps:
receiving at the transaction server from the first party and/or second party, via the communications network, transaction data that includes the second agreed minimum amount of funds required to be deposited in the sub-holding account;
updating the transaction database to store the second agreed minimum amount of funds required to be held in the sub-holding account in a funds record;
retrieving from the transaction database the funds record corresponding to the second agreed minimum amount of funds required to be held in the sub-holding account before the subcontracting party will commence the subset of the services;
comparing the funds data with the funds record corresponding to the second agreed minimum amount of funds required to be held in the sub-holding account to determine whether the funds held in the sub-holding account represent at least the second agreed minimum amount of funds required to be held in the sub-holding account; and
updating the transaction database to mark a transaction record corresponding to the sub-holding account as containing the second agreed minimum amount of funds.

9. The computer-implemented method according to claim 7, wherein at least a portion of the funds held in the sub-holding account are received from the further second party transaction account.

10. The computer-implemented method according to claim 7, wherein the second party transaction account is the same as the further second party transaction account.

11. The computer-implemented method according to claim 7, wherein at least a portion of the funds held in the sub-holding account are received from a third party transaction account as a result of a pre-existing credit arrangement between the second party and a third party finance provider.

12. The computer-implemented method according to claim 7, wherein the sub-holding account is facilitated by a financial institution or third-party transaction service provider and managed by the payment server.

13. The computer-implemented method according to claim 7, wherein the sub-holding account can also receive funds payable to one or more additional subcontracting parties on account of those additional subcontracting parties performing services specified in the service agreement.

14. The computer-implemented method according to claim 7, wherein the step of transmitting from the transaction server to the payment server authorisation data to enable the transfer of at least the second agreed minimum amount of funds from the sub-holding account to the subcontracting party transaction account is independent of and can precede the step (g) of transmitting from the transaction server to the payment server authorisation data to enable the transfer of at least the agreed minimum amount of funds from the holding account to the second party transaction account.

15. The computer-implemented method according to claim 8, wherein the transaction data further includes one or more of:
a transaction identifier associated with the holding account; and
a transaction identifier associated with second party transaction account.

16. Software when installed on a server causes the server to perform the method according to claim 1.

17. A computer system for facilitating a payment transaction between a first party transaction account and a second party transaction account; the computer system comprising:
a computer server accessible through a communications network, the computer server arranged to receive transaction data through the communications network;
a processor, communicatively coupled to the computer server, to one or more means for graphical display of information, and to one or more means for receiving input, the processor being configured to:
(a) receive at the computer server funds data indicative of funds held in a holding account, the funds held in the holding account being received from the first party transaction account and being payable to the second party transaction account on account of services to be provided by a second party to a first party under a service agreement;
(b) automatically transmit to the second party, via a communications network, a notification that an agreed minimum amount of funds has been deposited in the holding account;
(c) receive from the second party, via the communications network, performance data representative of completion by the second party of services specified in the service agreement;
(d) update a transaction database to mark a performance record corresponding to services specified in the service agreement as being completed by the second party;
(e) automatically transmit to the first party, via the communications network, a notification that the second party has indicated performance of the services specified in the service agreement;
(f) receive from the first party, via the communications network, confirmatory performance data representative of approved completion by the second party of services specified in the service agreement;
(g) transmit from the computer server to a payment server authorised to action transactions from the holding account, via the communication network, authorisation data to enable the transfer of at least the agreed minimum amount of funds from the holding account to the second party transaction account.

18. The computer system according to claim 17, wherein the processor is further configured to:
receive at the computer server funds data indicative of funds held in a sub-holding account, the funds held in the sub-holding account being received from a further second party transaction account and being payable to a subcontracting party transaction account on account of a subset of the services to be provided by a subcontracting party to the second party;
automatically transmit to the subcontracting party, via a communications network, a notification that a second agreed minimum amount of funds has been deposited in the sub-holding account;
receive from the subcontracting party, via the communications network, performance data representative of completion by the subcontracting party of the subset of the services;
update the transaction database to mark a performance record corresponding to services specified in the service agreement as being completed by the subcontracting party;
automatically transmit to the first party and/or the second party, via the communications network, that the subcontracting party has indicated performance of the subset of the services;
receive from the first party and/or the second party, via the communications network, confirmatory performance data representative of approved completion by the subcontracting party of the subset of the services; and
transmit from the computer server to a payment server authorised to action transactions from the sub-holding account, via the communication network, authorisation data to enable the transfer of at least the second agreed minimum amount of funds from the sub-holding account to the subcontracting party transaction account.

19. The computer system according to claim 18, wherein the step of transmitting from the computer server to the payment server authorisation data to enable the transfer of at least the agreed minimum amount of funds from the sub-holding account to the subcontracting party transaction account is independent of and can precede the step of transmitting from the computer server to the payment server authorisation data to enable the transfer of at least the agreed minimum amount of funds from the holding account to the second party transaction account

20. A method as performed by a payment transaction application installed on a mobile communication device to facilitate a payment transaction between a first party transaction account and a second party transaction account, the payment transaction relating to a service agreement between a first party and a second party, the method comprising:
(a) receiving from a transaction server, via a communications network, a notification that an agreed minimum amount of funds has been deposited in a holding account;
(b) transmitting to the transaction server, via the communications network, performance data representative of completion by the second party of services specified in the service agreement;
(c) receiving from the transaction server, via the communications network, confirmatory performance data representative of approval by the first party of the services completed by the second party; and
(d) receiving from the transaction server, via the communication network, a notification that the transfer of at least the agreed minimum amount of funds from the holding account to the second party transaction account has been authorised.

21. The method according to claim 20, wherein the communication device comprises a display device to facilitate interaction by the first party and/or second party with the payment transaction application.

22. The method according to claim 20, wherein in step (b) the performance data may also include one or more digital images illustrating the services performed by the second party in accordance with the service agreement.

23. Software that when installed on a mobile communication device causes the mobile communication device to perform the method according to claim 20.

24. An Application Programming Interface that when installed on a mobile communications device as part of a payment transaction application causes the mobile communication device to perform the method according to claim 20.
